(19) United States
(12) Patent Application Publication
(10) Pub. No.: US 2026/0358767 A1
(43) Pub. Date: Nov. 12, 2026

(54) BUILDING MANAGEMENT SYSTEM WITH NATURAL LANGUAGE DATA RETRIEVAL

(71) Applicant: Tyco Fire & Security GmbH, Neuhausen am Rheinfall (CH)

(72) Inventor: Shweta Akshay Kolwalkar, Lithia, FL (US)

(21) Appl. No.: 19/665,895

(22) Filed: May 1, 2026

Related U.S. Application Data
(60) Provisional application No. 63/801,522, filed on May 7, 2025.

(51) Int. Cl. G05B 13/02

(52) U.S. Cl. CPC G05B 13/027

(57) ABSTRACT

A Building Management System (BMS) can include one or more memory devices that can store instructions thereon that, when executed by one or more processors, cause the one or more processors to receive data that represents one or more building graphs, generate a graph digest including one or more relationship clusters, train a large language model (LLM) on one or more relationship clusters of the graph digest, and provide a prompt to the LLM to cause the LLM to generate a graph query configured to traverse a given portion of the building graph based on the prompt.

### CROSS REFERENCE TO RELATED APPLICATIONS

The present application claims priority to, and the benefit of, U.S. Provisional Patent Application No. 63/801,522, filed May 7, 2025, the disclosure of which is incorporated herein by reference in its entirety and for all purposes.

### BACKGROUND

The present disclosure relates generally to building management systems. The present disclosure relates more particularly to systems for managing and processing data of building systems.

### SUMMARY

At least one embodiment relates to a building management system (BMS). The building management system can include one or more memory devices having instructions stored thereon that, when executed by one or more processors, cause the one or more processors to perform operations. The system can receive data that represents one or more building graphs, the one or more building graphs including (1) a plurality of nodes that represent entities of a building and (2) edges that represent relationships between the plurality of nodes. The system can generate, using the data, a graph digest comprising one or more relationship clusters within the one or more building graphs, the relationship clusters comprising extractions of a plurality of portions of the one or more building graphs. The system can train, using one or more relationship clusters of the graph digest, a large language model (LLM) to process a context of the one or more building graphs such that the trained LLM is configured to generate graph queries to traverse given portions of the plurality of portions to retrieve corresponding information from the given portions responsive to one or more input queries.

In some implementations, the system can receive an input query for a first set of information associated with one or more aspects of a building. In some implementations, the system can generate a prompt based on one or more aspects of the input query and one or more aspects of the graph digest. In some implementations, the system can provide, as one or more inputs, the prompt to the LLM to cause the LLM to generate a graph query for the building graph. In some implementations, the system can traverse a given portion of the building graph based on the graph query and retrieve corresponding information from the given portions.

In some implementations, the system can identify reasoning of one or more stored input queries or one or more clusters of stored input queries based on a context of the input query, wherein the reasoning includes one or more related queries, answers, or reasoning of the one or more stored input queries or the one or more clusters of stored input queries. In some implementations, the system can generate the prompt based on the one or more aspects of the input query, the one or more aspects of the graph digest, and one or more aspects of the reasoning.

In some implementations, the system can generate a summary of the given portion of the building graph based on the retrieved corresponding information. In some implementations, the system can determine an additional prompt based on one or more aspects of the input query, one or more aspects of the graph digest, and one or more aspects of the summary. In some implementations, the system can provide the additional prompt to the LLM to cause the LLM to generate a new graph query for the building graph to traverse given portions of the plurality of portions to retrieve corresponding information from the given portions responsive to the new graph query.

In some implementations, the system can determine that the corresponding information satisfies the input query for the first set of information. In some implementations, the system can transmit, responsive to execution of the graph query, an electronic message to the computing device to provide the first set of information.

In some implementations, the system can generate a summary of the given portion of the building graph based on the retrieved corresponding information. In some implementations, the system can retrieve stored input queries consisting of data corresponding to an encapsulation of a natural language query and a corresponding natural language result. In some implementations, the system can associate stored input queries into clusters based on similarity between the natural language query and corresponding natural language result of the stored input queries.

In some implementations, the system can identify reasoning of one or more stored input queries or one or more clusters of stored input queries with a highest similarity to a context of the received input query, wherein the reasoning includes information including one or more related queries, answers, and reasoning of one or more stored input queries or one or more clusters of stored input queries to the context of the received input query. In some implementations, the system can determine an additional prompt based on one or more aspects of the input query, one or more aspects of the graph digest, one or more aspects of a summary of the corresponding information, and one or more aspects of the reasoning. In some implementations, the system can provide the additional prompt to the LLM to cause the LLM to generate a new graph query for the building graph.

In some implementations, the system can traverse a given portion of the building graph based on the graph query and retrieve corresponding information from the given portions. In some implementations, the system can determine the corresponding information satisfies the input query for the first set of information. In some implementations, the system can transmit, responsive to execution of the graph query, an electronic message to the computing device to provide the first set of information.

In some implementations, the graph query generated by the LLM comprises a query configured to be executed on a cloud-based graph engine storing the building graph to retrieve a portion of the building graph without rendering the entire building graph.

In some implementations, the one or more relationship clusters of the graph digest comprise clusters of nodes and edges grouped according to node class hierarchies including a general node class, a parent node class, and one or more node class types corresponding to building or equipment parameters.

At least one other aspect relates to a method. The method can be performed, for example, by one or more processors coupled to non-transitory memory. The method can include receiving data that represents one or more building graphs, the one or more building graphs including (1) a plurality of nodes that represent entities of a building and (2) edges that represent relationships between the plurality of nodes. The method can include generating, using the data, a graph digest comprising one or more relationship clusters within the one or more building graphs, the relationship clusters comprising extractions of a plurality of portions of the one or more building graphs. The method can include training, using one or more relationship clusters of the graph digest, a large language model (LLM) to process a context of the one or more building graphs such that the trained LLM is configured to generate graph queries to traverse given portions of the plurality of portions to retrieve corresponding information from the given portions responsive to one or more queries. The method can include receiving a query relating to the building. The method can include generating, using the trained LLM, a response to the query by prompting the trained LLM to generate one or more graph queries into the one or more building graphs using the context obtained by training the LLM using the graph digest.

In some implementations, the method can include receiving an input query for a first set of information associated with one or more aspects of a building. In some implementations, the method can include generating a prompt based on one or more aspects of the input query and one or more aspects of the graph digest. In some implementations, the method can include providing, as one or more inputs, the prompt to the LLM to cause the LLM to generate a graph query for the building graph. In some implementations, the method can include traversing a given portion of the building graph based on the graph query and retrieving corresponding information from the given portions.

In some implementations, the method can include identifying reasoning of one or more stored input queries or one or more clusters of stored input queries based on a context of the input query, wherein the reasoning includes one or more related queries, answers, or reasoning of the one or more stored input queries or the one or more clusters of stored input queries. In some implementations, the method can include generating the prompt based on the one or more aspects of the input query, the one or more aspects of the graph digest, and one or more aspects of the reasoning.

In some implementations, the method can include generating a summary of the given portion of the building graph based on the retrieved corresponding information. In some implementations, the method can include determining an additional prompt based on one or more aspects of the input query, one or more aspects of the graph digest, and one or more aspects of the summary. In some implementations, the method can include providing the additional prompt to the LLM to cause the LLM to generate a new graph query for the building graph to traverse given portions of the plurality of portions to retrieve corresponding information from the given portions responsive to the new graph query.

In some implementations, the method can include determining that the corresponding information satisfies the input query for the first set of information. In some implementations, the method can include transmitting, responsive to execution of the graph query, an electronic message to the computing device to provide the first set of information.

In some implementations, the method can include generating a summary of the given portion of the building graph based on the retrieved corresponding information. In some implementations, the method can include retrieving stored input queries consisting of data corresponding to an encapsulation of a natural language query and a corresponding natural language result. In some implementations, the method can include associating stored input queries into clusters based on similarity between the natural language query and corresponding natural language result of the stored input queries.

In some implementations, the method can include identifying reasoning of one or more stored input queries or one or more clusters of stored input queries with a highest similarity to a context of the received input query, wherein the reasoning includes information including one or more related queries, answers, and reasoning of one or more stored input queries or one or more clusters of stored input queries to the context of the received input query. In some implementations, the method can include determining an additional prompt based on one or more aspects of the input query, one or more aspects of the graph digest, one or more aspects of a summary of the corresponding information, and one or more aspects of the reasoning. In some implementations, the method can include providing the additional prompt to the LLM to cause the LLM to generate a new graph query for the building graph.

In some implementations, the method can include traversing a given portion of the building graph based on the graph query and retrieving corresponding information from the given portions. In some implementations, the method can include determining the corresponding information satisfies the input query for the first set of information. In some implementations, the method can include transmitting, responsive to execution of the graph query, an electronic message to the computing device to provide the first set of information.

At least one other aspect relates to one or more non-transitory storage media storing instructions thereon that, when executed by one or more processors, cause the one or more processors to perform operations. The one or more processors can receive, from one or more data sources, data that represents one or more building graphs, the one or more building graphs including (1) a plurality of nodes that represent entities of a building and (2) edges that represent relationships between the plurality of nodes. The one or more processors can generate, using the data, a graph digest comprising one or more relationship clusters within the one or more building graphs, the relationship clusters comprising extractions of a plurality of portions of the one or more building graphs. The one or more processors can train, using one or more relationship clusters of the graph digest, a large language model (LLM) to process a context of the one or more building graphs such that the trained LLM is configured to generate graph queries to traverse given portions of the plurality of portions to retrieve corresponding information from the given portions responsive to one or more input queries.

In some implementations, the one or more processors can receive an input query for a first set of information associated with one or more aspects of a building. In some implementations, the one or more processors can generate a prompt based on one or more aspects of the input query and one or more aspects of the graph digest. In some implementations, the one or more processors can provide, as one or more inputs, the prompt to the LLM to cause the LLM to generate a graph query for the building graph. In some implementations, the one or more processors can traverse a given portion of the building graph based on the graph query and retrieve corresponding information from the given portions.

Some implementations relate to a method including, receiving, from one or more data sources by one or more processing circuits, data that represents one or more building graphs, the one or more building graphs including (1) a plurality of nodes that represent entities of a building and (2) edges that represent relationships between the plurality of nodes, generating, by the one or more processing circuits using the data, a graph digest including one or more relationship clusters within the one or more building graphs, the relationship clusters including extractions of a plurality of portions of the one or more building graphs, training, by the one or more processing circuits using one or more relationship clusters of the graph digest, a large language model (LLM) to process a context of the one or more building graphs such that the trained LLM is configured to generate graph queries to traverse given portions of the plurality of portions to retrieve corresponding information from the given portions responsive to one or more queries; receiving, by the one or more processing circuits, a query relating to the building, and generating, by the one or more processing circuits using the trained LLM, a response to the query by prompting the trained LLM to generate one or more graph queries into the one or more building graphs using the context obtained by training the LLM using the graph digest.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a building management system including a graph management system, according to some embodiments.

FIG. 2 is a digital representation of a database representing one or more entities of a building, according to an exemplary embodiment.

FIG. 3 is a digital representation of nodes included in the database of FIG. 2, according to an exemplary embodiment.

FIG. 4 is a digital representation of the database of FIG. 2, according to an exemplary embodiment.

FIG. 5 is a flow diagram of a self-improvement framework for a building management system, according to an exemplary embodiment.

FIG. 6 is a block diagram of a digitization workflow of creation of a virtual representation of a building, according to an exemplary embodiment.

FIG. 7 is a flow diagram of a system for retrieving information from the database of FIG. 2, according to an exemplary embodiment.

FIG. 8 is a flow diagram of a process for generating a graph query for a building management system, according to an exemplary embodiment.

### DETAILED DESCRIPTION

Various interactions between building systems, components of building systems, users, technicians, and/or devices managed by users or technicians can rely on timely generation and presentation of relevant information relating to user queries. However, digital representations of buildings can be large and complex. For example, a digital twin can include detailed models of structural elements, HVAC systems, electrical networks, and/or other subsystems, resulting in a large dataset. It can be difficult for machine learning models such as large language models (LLMs) to be strained on such large structures and/or process queries using such large structures to generate accurate, contextually relevant responses. For example, an LLM can struggle to provide precise maintenance recommendations when processing the entire digital twin of a large commercial building.

Additionally, it can be difficult and/or cumbersome to generate relevant data in response to the user queries. For example, obtaining relevant information in response to user queries has traditionally required expert analysis or specific query language corresponding to predetermined schema vocabulary. That is, it can be difficult and/or cumbersome to query relevant data when a digital-twin model has to be rendered. For example, generating a real-time status report for all systems within a digital twin of a hospital can be a complex and time-consuming task.

Referring generally to the FIGURES, building management systems are shown, according to various exemplary embodiments. In some embodiments, a building management system can train an LLM to filter a sub-graph based on a user’s natural language query. In some embodiments, the building management system can facilitate or execute targeted queries of sub-portions within a graph database. In some embodiments, the building management system can use natural language prompts as a constraint or input to a large language model (LLM) that is trained to generate graph queries.

In some embodiments, the building management system described herein can facilitate the management and control of a building. For example, the building management system can provide for efficiently traversing a digital twin of a building. That is, the building management system can provide agility, flexibility, and scalability for building management. In some embodiments, the building management system can allow users to manage operations with buildings that have memory, intelligence, and unique identities. For example, the building management system can perform energy and space optimization, predictive maintenance, and/or remote operations. Although the building management system is described for a building, e.g., for building subsystems of a building (e.g., for HVAC systems, security systems, access control systems, elevator systems, fire response systems, etc.), in some embodiments, the building management system can be applied to other industries (e.g., motor vehicles, airports, manufacturing systems, transit systems, airplanes, and/or any other type of system where the management of devices is desired). In some embodiments, the building management system can provide seamless integration of devices regardless of brand, make, model, or subsystem.

A building can include various types of building subsystems (e.g., heating, ventilation, and air conditioning (HVAC) systems, security systems, fire response systems, etc). Discrete predefined controlling systems can operate each subsystem individually without knowledge of the building. However, discrete predefined controlling systems may not allow for dynamic, scalable, and adjustable solutions that can provide holistic management of a building.

A building and the multiple systems within a building can be represented and managed by a digital twin of the building. Digital twins can be digital replicas of physical entities that enable an in-depth analysis of data of the physical entities and provide the potential to monitor systems to mitigate risks, manage issues, and utilize simulations to test future solutions. Digital twins can be digital representations of a physical environment (e.g., a building). Digital twins can play an important role in helping technicians find the root cause of issues and solve problems faster, in supporting safety and security protocols, and in supporting building managers in more efficient use of energy and other facilities resources. Digital twins can be used to augment and unify security systems, employee experience, facilities management, sustainability, etc.

In some embodiments, the building management system can be configured to track the building subsystems by storing entities (e.g., data representing equipment, buildings, spaces, floors, software services, policies, etc.), relationships (e.g., relationships between equipment and their locations, API calls between software services, etc.), events (e.g., data that has occurred, measurements, commands, statuses, etc.), and/or other building management information. In some embodiments, the digital twin can create and be represented by graph projections, e.g., a graph with nodes that represent entities and/or events, and edges for the relationships between the entities and/or events.

In some embodiments, graph projections can be built on particular policies (e.g., what entities, events, and/or relationships should be included within the graph) and/or ontologies (the types of relationships that should be made with different types of entities and/or events). For example, particular graph projections can be generated for particular subscribers, users, systems, etc. That is, graphs can include resource description framework (RDF) graphs that conform to and/or adhere to one or more schemas. For example, an RDF graph can conform to the Brick schema. The Brick schema can provide or represent a standardized semantic description of one or more assets of a building. For example, the Brick schema can include semantic descriptions of physical or logical assets of a building.

In some embodiments, the graph can include nodes and edges. The nodes and the edges can be defined according to a key (e.g., schema, ontology, etc.). The nodes can represent different types of entities, devices, locations, points, persons, policies, and software services (e.g., API services). The edges can represent relationships between the nodes such as, dependent calls, API calls, inferred relationships, and schema relationships (e.g., Brick relationships). In some embodiments, the nodes can represent subjects, predicates, and objects available in the current building context, with various relationships and filtered graph points. The filtered graph points are relevant to queried relationships.

In some embodiments, similar relationships can be used with other digital representations of the building that may not be stored in a graph form. For example, a rules-based system can define relationships between building components using a hierarchical data model instead of a graph, where dependencies and interactions can be captured through predefined rules in addition to, or alternatively to, explicit node-edge structures. That is, a BMS can use a structured hierarchy where equipment, zones, and floors are organized in a tree-like format, allowing for efficient querying of relationships. For example, a query could retrieve all HVAC units serving a specific floor or identify dependencies between lighting controls and occupancy sensors based on predefined rules.

In some embodiments, the building management system can include multiple components (e.g., a graph management system, a building schema, a graph digest, a network, and/or a database). The graph management system can facilitate connection for the building management system directly to the building systems. The graph management system can facilitate receiving, collecting, and/or retrieving data from the building subsystems. In some embodiments, the graph management system can facilitate the command and control of the building systems for the building management system.

The network can be configured to facilitate message control for the building management system. The building management system can be configured to receive messages of the building subsystems through the network and manage the messages. The network can route messages around the building management system. Furthermore, the building management system can facilitate directing operational commands for the building subsystems to the building subsystems through the network. In some embodiments, graph management system is configured to enrich messages received from the database. The graph management can be configured to add contextual information to event messages received from the building subsystems via the network. The contextual information can be utilized by applications that consume the event messages and can allow for the applications to immediately have access to the contextual information instead of requiring the applications to query another system to receive contextual information.

Buildings and/or subsystems thereof are complex entities. For example, buildings and/or subsystems can have multiple parallel systems (e.g., HVAC systems, building physical partitions and locations, controllers, sensor connection, etc.). The systems can be interconnected with varied and entangled types of relationships. Accordingly, digital representations of a building (e.g., a graph, a database, virtual representation, etc.) are often complex. For example, a graph can have a magnitude of relationships, which can make any type of graph visualization not comprehendible to a user. The magnitude of relationships and possible queries creates problems of inefficient data handling, computational power, and a frustrated user experience, among other issues. Moreover, in order to show relevant sub-parts of a graph or relevant data point, the complete graph is rendered.

Additionally, utilization of an RDF graph for providing any information for a user-query is a complex operation. Often, a digital twin of the building is rendered as a 3D-graphical representation for the user to traverse across various locations in the building and see the relationships between various entities. For example, a user can check which air handling unit (AHU) is feeding to current rooms or to variable air volume (VaV) systems. For example, a user can check whether a given sensor is controlled by a certain controller. The 3D rendering requires a magnitude of time and computational power to load and stream the large amount of data from the cloud to the user. The computational power needed can impact user-experience and can slow overall application performance.

Some implementations may utilize pre-made relationship reports to provide a user with nodes relationship info, but given the large number of combination of relationships possible, only frequently used relationships are stored and made available to the user. These reports may lack any attached intelligence. As a result, users may be tasked with figuring out how to correlate different reports and reach the desired query or relationships. Additionally, the user must also determine whether the desired query or relationships are even feasible. Additionally, using a tool to write an appropriate query requires an expert to develop an understanding of the given Brick graph and different nodes available in the current building context. This further requires filtering graph points, which are relevant to queried relationships.

3D rendering of digital twin data can be a data-intensive operation on a system such as a cloud-based memory system due to the necessity of the complete building model to be served every time a user submits a query, requiring a heavy cost. Additionally, injections into LLMs often create problems and limitations. For example, LLMs are prone to hallucination when sourcing new info. Additionally, some LLM calls are billed based on a number of tokens-fed and tokens generated. Many LLMs need to be fed massive amounts of input, driving up costs. Current Retrieval-Augmented Generation (RAG) approaches include relevant information first searched in the graph using vector search. Information fed to LLMs using a RAG approach are dependent on the amount of information fed to the LLM, creating problems with required data size and/or usage for current approaches to work. Often times, there is no way to make sure enough information has been passed to the LLM in every call.

Some technical solutions described herein include creating an RDF graph that allows a user to traverse small sub-graph from a larger graph. This can be done using a natural language generative artificial intelligence (GenAI) based approach and training a large language model (LLM) on how to filter the sub-graph based on a user’s natural language query. For example, the systems and methods described herein can provide for an automated procedure to create a digest of a large RDF graph for training a GenAI model to understand the overall context in which it has to filter the graph and providing a selection of the entire graph to the LLM. The RDF graph is the traversed in natural ways using a chain of thought, plain language approach, aimed at collecting relevant points by travelling in depth of the graph based on the outputs of the previous steps. This approach mimics the natural process of writing the draft query and generates more accurate results.

Additionally, the techniques described herein can feed portions, relationship clusters, or a summary of the graph and not the entirety of data inside it, allowing for an improvement in LLM calls, decreasing cost, token-size, and generating a lower response time. Given the defined nature of input-token-size, the techniques allow for more predictability on the cost per call. Additionally, the techniques can allow for an improvement on the amount of information needed to be fed to the LLM given the dynamic size of nodes in a graph. For example, a prompt can be created based on portions of a graph digest, a user query, reasoning from past input queries, and summary of information from past graph queries and fed as input into the LLM trained on aspects of the graph digest to generate graph queries. Having a defined task of writing a query for which the required information is given in the digest allows for an output query that will fetch all the information asked for by the user. Additionally, the LLM receiving context from relevant examples allow the LLM to restrict hallucination and give a stronger structure to the response.

The technical solutions can include running a graph engine (e.g., in the background or on the cloud) to perform the queries and provide the user only with the sub-graph data. The system can thus use any previous responses as an example for single shot learning for LLMs, which helps in caching the response and providing the user with more accurate responses with further usage of the application. The technical solution can use building schema to answer user query related to building structure and connection between various entities without any rendering of a digital-twin model. The solution can instead include, for example, a natural chat style interface. The solution can use a multi-step approach to implement the system. One step of the system can include training the LLM by providing it with a generated concise context of the graph that stores all unique information about the graph, allowing the LLM to understand the larger (e.g., entire) context of the graph without feeding it the complete graph. This solution step can mimic the manual process of writing a graph query. Additionally, this approach does not rely on an LLM to generate any information or output a direct response for the user. Instead, LLMs can be used as a tool for the developed internal process to generate queries only. The LLMs can be previously trained on large corpuses of data, queries, prompts, code (e.g., PySql code), making it well within its limits to generate queries.

The technical solutions described herein can include generating graph queries dynamically. Graph queries can be generated by running on a schema based RDF-graph of the building. The graph queries can additionally be generated and executed on a cloud-based graph engine to filter selections of a sub-graph relevant to the required context. A chain of thoughts/reasoning-with-observations (RWO) approach can be used to retrieve information from a graph in an iterative way and can be used to traverse the depth of the graph to get the desired points. Example solutions can therefore solve in-depth queries by travelling from overall building context to narrow systems and processes, for example individual sensor levels.

In some embodiments, Brick-schema can be used as a standardized framework for representing and querying building data. Brick provides a structured ontology that categorizes building components, such as HVAC systems, lighting, sensors, zones, and/or other components, along with their interrelationships. Queries can be run on a Brick-schema-based RDF graph using SPARQL or other graph query languages to retrieve specific building data. For example, a query could identify all temperature sensors in a particular room, trace their connectivity to HVAC systems, and determine control dependencies.

In some embodiments, other schemas and/or ontologies may be used to represent a structured framework or organization of a building. For example, other schema can provide a tagging-based system to label building data points for data organization and retrieval. Other ontologies may integrate smart buildings with business processes, property managements, and/or IoT platforms, allowing structured queries to be used to facilitate data-driven decision making.

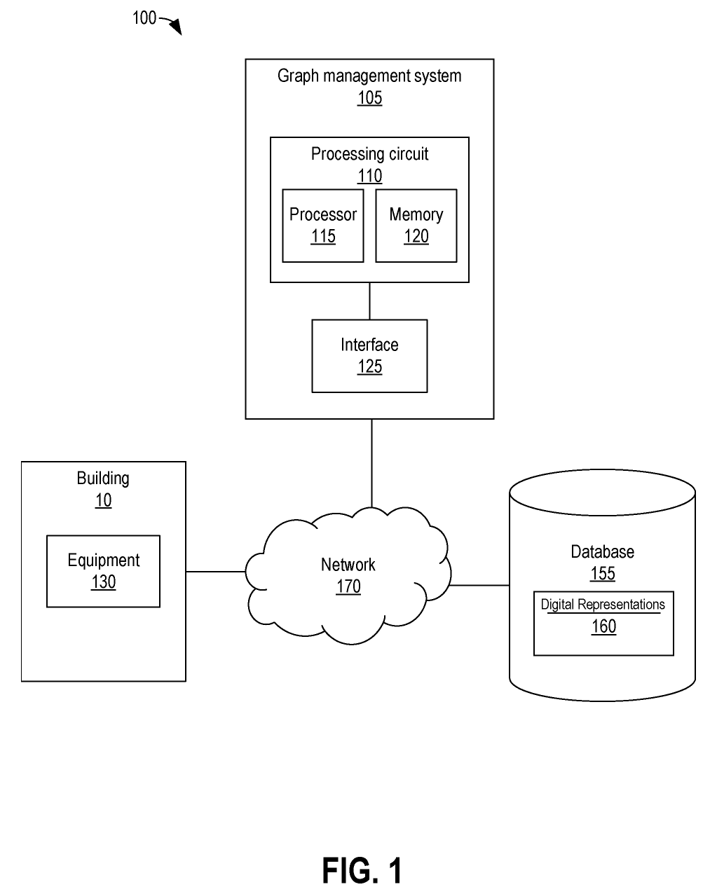

FIG. 1 depicts a system 100, according to some embodiments. The system 100 can include a graph management system 105, network 170, building 10, and/or database 155. The system 100 can include and/or be implemented as at least one of the various systems or used to implement any of the examples or implementations described herein. For example, one or more processors 115 can execute self-improvement framework 500. In some embodiments, systems, components, and/or devices of the system 100 may be added, removed, integrated, combined, separated, rearranged, relocated and/or replaced. For example, a device of the system 100 that may be shown to include two components may be modified such that the two components are combined into a single component. As another example, a component that is shown to be included in a first device may also be added to a second device. Each system or device in the system 100 may include one or more processors 115, memories 120, interfaces 125 (e.g., network interfaces, user interfaces, etc.), and/or other components. The memories may store programming logic that, when executed by the processors, controls the operation of a corresponding computing system or device. The memories may also store data in databases.

In some embodiments, the system 100 may include at least one graph management system 105, at least one database 155, and least one network 170, and the building 10. In some embodiments, systems, devices, and/or components of the system 100 may be in communication with one another. For example, a first device may transmit signals to a second device. In some embodiments, the communication may include wireless communication. For example, the communication may include communication via a Wireless Local Area Network (WLAN). In some embodiments, the communication may include wired connection. For example, the communication may include communication via wires and/or cables.

In some embodiments, the database 155 may include similar components to at least one of the various systems and/or devices described herein. For example, the database 155 may include at least one of servers, remote computing systems, a cloud-based system, remote databases, and/or other possible cloud computing systems. In some embodiments, the database 155 may include similar components to at least one of the various systems and/or devices described herein. For example, the database 155 may include digital representation(s) 160. In some embodiments, the database 155 may perform operations similar to that of at least one component and/or devices described herein. For example, the database 155 may perform operation similar to that of monitoring and reporting digital representation(s) 160. While FIG. 1 depicts the database 155 as being separate from the graph management system 105, the database 155 may be integrated with and/or included in the graph management system 105. For example, the graph management system 105 may be distributed across one or more remote databases (e.g., the database 155).

In some embodiments, the database 155 may include at least one of the various types of memory and/or memory devices described herein. For example, the database 155 may include memory 120. In some embodiments, the database 155 may store and/or include one or more digital representations 160. The digital representations 160 may include digital models, data structures, or other electronic records that represent one or more aspects of a building, including but not limited to building graphs, equipment data, spatial layouts, sensor configurations, control relationships, and system interconnections. In some embodiments, the digital representations 160 may include at least one of the various mappings described herein (e.g., point mappings). For example, the digital representations 160 may include point mappings between point objects and one or more variables. As another example, digital representations 160 may include a notation system for data held by nodes and/or relationships represented by edges. Nodes and/or edges can be labeled as any of a subject, predicate, and/or object. In some embodiments, the database 155 can include a graph digest. A graph digest can include a summary, context, relationship clusters, and/or any data or portions of data of a graph.

In some embodiments, labels may be available in the current building context and filter graph points, which are relevant to queried relationships. For example, a subject node may include a category assignment for generalization (e.g., types of equipment, location information, etc.). Additionally, a predicate node may contain a digest of all relationships and/or edges with a possible subject and object nodes type, (e.g., relationships between equipment, relationships between locations, relationships between equipment and locations, etc.). Additionally, an object node may contain descriptions of a node and their relationships with other subject nodes, predicates, and/or objects. As another example, the digital representations 160 may map pieces of equipment and/or equipment types to one or more parameters (e.g., building parameters including entity, point classes, location classes, equipment classes, etc).

In some embodiments, the digital representations 160 may include relationships (e.g., relationships 206) between one or more aspects of the building 10. As an example, a building graph (e.g., building graph produced by graph management system 105) can include nodes that represent entities of a building (e.g., building) and edges that represent relationships between the plurality of nodes. For example, the digital representations 160 may indicate that a given a piece of equipment (e.g., AHU) has given setpoints (e.g., one or more parameters). As another example, the digital representations 160 may indicate that a given node (e.g., AHU or other piece of equipment), has an edge constituting a relationship with another node (e.g., VAV or other piece of equipment). As another example, the digital representations 160 may indicate that a given controller is communicably coupled with a given VAV and that the given controller is able to control the given VAV.

In some embodiments, the building 10 may include equipment 130. In some embodiments, the equipment 130 may include at least one of the various pieces of equipment and/or equipment systems described herein. For example, the equipment 130 may include an AHU. In some embodiments, the equipment may be controllable by a controller. In some embodiments, the building 10 may include at least one of gateways, switches, routers, network devices, hubs, bridges, and/or other possible devices that may connect one or more devices to one another. For example, the building 10 may include at least one of gateways, switches, routers, network devices, hubs, bridges, and/or other possible devices that may connect one or more devices to one another. For example, the building 10 may include a gateway and the gateway may connect, over a network, a first device with a second device. In some embodiments, the gateway may connect the graph management system 105 with at least one component and/or device of the building 10. For example, the gateway may connect the graph management system 105 with the equipment 130.

In some embodiments, the graph management system 105 may be communicably coupled with the equipment 130 of the building 10. In some embodiments, the graph management system 105 may be stored in a cloud database, cloud service, cloud storage, online storage, internet-based service, virtual server, or other system service storage. In some embodiments, the graph management system 105 may be integrated and/or in communication with a mobile device. For example, the graph management system 105 may be in communication with a client device. In some embodiments, a user and/or an operator of a client device may integrate with the graph management system 105 and the client device may perform at least one of the various operations described herein. In some embodiments, the graph management system 105 may be in communication with at least one of a smartphone, a tablet, a smart watch, a computer, a laptop, a desktop computer, and/or a device that may facilitate receiving and/or transmitting of information.

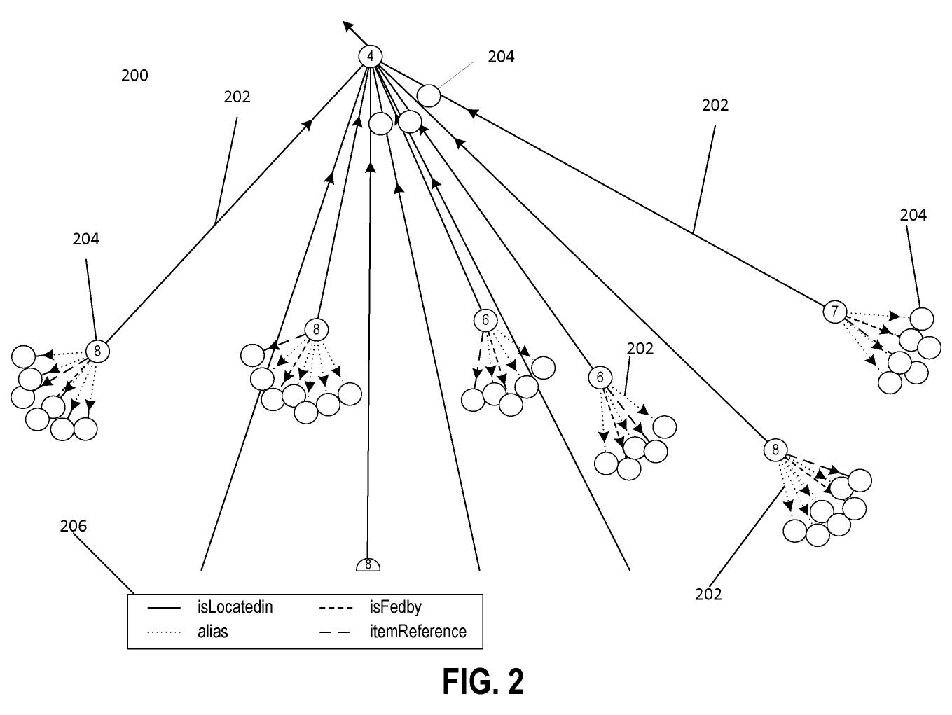

In some embodiments, the graph management system 105 may include at least one processing circuit 110 and at least one interface 125. In some embodiments, the interface 125 may include at least one of a Human-Machine Interface (HMI), a communication interface, a network interface, a transmitter, an antenna, a receiver, and/or a transceiver. In some embodiments, the interface 125 may include at least one display device (e.g., a screen, a monitor, a Liquid Crystal Display (LCD), a touch screen, an Input/Output (I/O) device, and/or other possible devices. In some embodiments, the interface 125 may communicate with at least one of the devices and/or components of the system 100. For example, the interface 125 may communicate with the equipment 130. In some embodiments, the processing circuit 110 may perform operations similar to that of the interface 125. In some embodiments, the network 170 may include at least one of gateways, switches, routers, network devices, hubs, bridges, and/or other possible devices that may connect one or more devices to one another. For example, the network 170 may include at least one of gateways, switches, routers, network devices, hubs, bridges, and/or other possible devices that may connect one or more devices to one another. In some embodiments, the graph management system 105 may communicate through network 170 to retrieve data from the database 155 to populate a graph, as discussed in FIG. 2.

In some embodiments, the processing circuit 110 may include at least one processor 115 and at least one memory 120. In some embodiments, the processors 115 may include at least one of the various processors, hardware, and/or circuitry described herein. In some embodiments, memory 120 may include at least one of the various types of memory described herein. In some embodiments, memory 120 may store instructions (e.g., computer code, software, and/or firmware. In some embodiments, the processors 115 may perform at least one of the various operations described herein responsive to the processors 115 executing instructions stored in memory 120. In some embodiments, memory 120 may store, reference, and/or include the database 155.

In some embodiments, the graph management system 105 may generate, provide, produce, and/or display at least one user interface. For example, the graph management system 105 may display at least one Graphical User Interface (GUI). In some embodiments, the user interfaces may be displayed via the interface 125. In some embodiments, the interface 125 may transmit signals to one or more devices and the one or more devices may display, responsive to receipt of the signals, one or more user interfaces. For example, the interface 125 may transmit signals to a client device(s) and the signals may cause a client device(s) to display one or more user interfaces.

In some embodiments, the graph management system 105 can include, access, and/or execute one or more machine learning models. That is, the graph management system 105 can store one or more machine learning models in memory 120 and/or retrieve one or more machine learning models from the database 155 via the network 170. The one or more machine learning models can include large language models (LLMs), neural networks, transformer-based models, encoder-decoder models, generative pretrained transformer (GPT) models, recurrent neural networks (RNNs), and/or convolutional neural networks (CNNs), among others. In some implementations, the graph management system 105 can provide data from the database 155 as input to the one or more machine learning models to cause the one or more machine learning models to generate one or more outputs. For example, the graph management system 105 can provide a portion of the digital representations 160 as input to an LLM to cause the LLM to generate a graph query for traversing one or more building graphs stored in the database 155.

In some implementations, the graph management system 105 can train the one or more machine learning models using data derived from the digital representations 160. For example, the graph management system 105 can generate a graph digest from one or more building graphs included in the digital representations 160 and train an LLM using one or more relationship clusters of the graph digest such that the LLM can generate graph queries to traverse given portions of the one or more building graphs. In some implementations, the graph management system 105 can constrain the one or more machine learning models to generate graph queries rather than generating direct factual responses to user queries. That is, the graph management system 105 can use the one or more machine learning models as internal tools for query generation, and the graph management system 105 can execute the generated graph queries against the database 155 to retrieve corresponding information from the one or more building graphs. In some implementations, the graph management system 105 can provide prompts to the one or more machine learning models, where each prompt can include one or more aspects of a user query, one or more aspects of a graph digest, and/or one or more aspects of previously generated reasoning and/or examples.

In some embodiments, the system 100 can include a network 170. The components of the system 100 can be communicably and operatively coupled to each other over a network, such as network 170. The network may include one or more of a cellular network, the Internet, Wi-Fi, Wi-Max, a proprietary provider network, a proprietary retail or service provider network, and/or any other kind of wireless or wired network. The network 170 can be structured and used to establish connections with other computing systems and devices (e.g., building 10, database 155, graph management system 105). In some arrangements, the network 170 includes the hardware (e.g., processor, memory, and so on) and machine-readable media sufficient to support communication over multiple channels of data communication.

FIG. 2 depicts a graph 200, according to some embodiments. The graph 200 can be visual or digital representation of a portion of a database (e.g., database 155) of the building management system of FIG. 1, according to some embodiments. In some embodiments, the graph 200 can be a physical depiction of an RDF framework (e.g., Brick ontology graph). For example, the graph 200 may be a representation of a portion of a digital twin of a building. In some embodiments, the graph 200 can include nodes 204, edges 202, and relationships 206. In some embodiments, digital representations (e.g., digital representations 160) can include nodes 204 and edges 202. In some embodiments, the nodes 204, edges 202, and relationships 206 contain data. According to some embodiments, edges 202 can represent relationships (e.g., relationships 206) between nodes 204. For example, the relationships 206 may include dependent calls (e.g., isLocatedIn, isFedby, etc.), inferred relationships (e.g., alias, itemReference, etc.), and schema relationships (e.g., Brick relationships).

In some embodiments, relationships of the graph can include subjects, predicates, and/or objects. For example, the relationships stored in the graph 200 can be represented as subjects, predicates, and objects. That is, a node 204 can be a subject, another node 204 can be an object, and the edge 202 can be the predicate describing the relationship between the subject and object. For example, a node 204 can represent and HVAC system in a building, another node 204 can represent a temperature sensor located in a specific room, and edge 202 can represent “monitors” as the predicate, indicating that the HVAC system monitors temperature through the sensor.

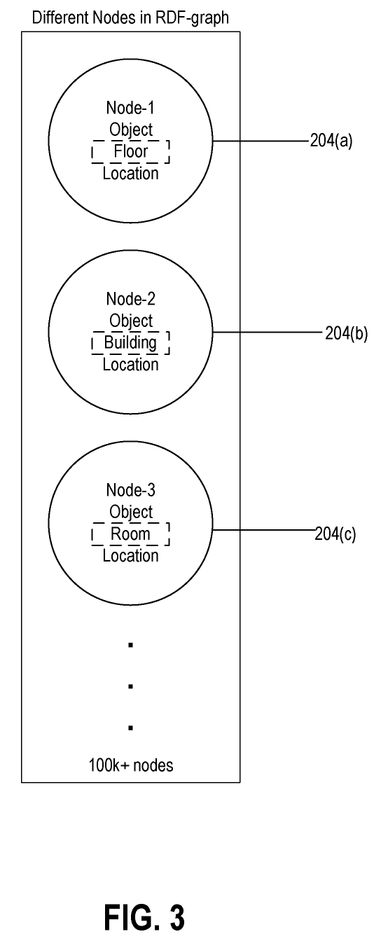

In some embodiments, subjects can represent a starting node (e.g., node 204) of a relationship (e.g., relationship 206) and/or the entity to be described. Additionally, a node can include a reference to a number of subjects, as shown in FIG. 3. For example, predicates can represent the edge 202 or link that describes the relationship (e.g., relationship 206) between the subject and the object. That is, a predicate can act as a verb or connector. In some embodiments, an object is the ending node of a relationship (e.g., relationship 206). That is, an object can represent the entity (e.g., node 204) that is related to the subject (e.g., node 204).

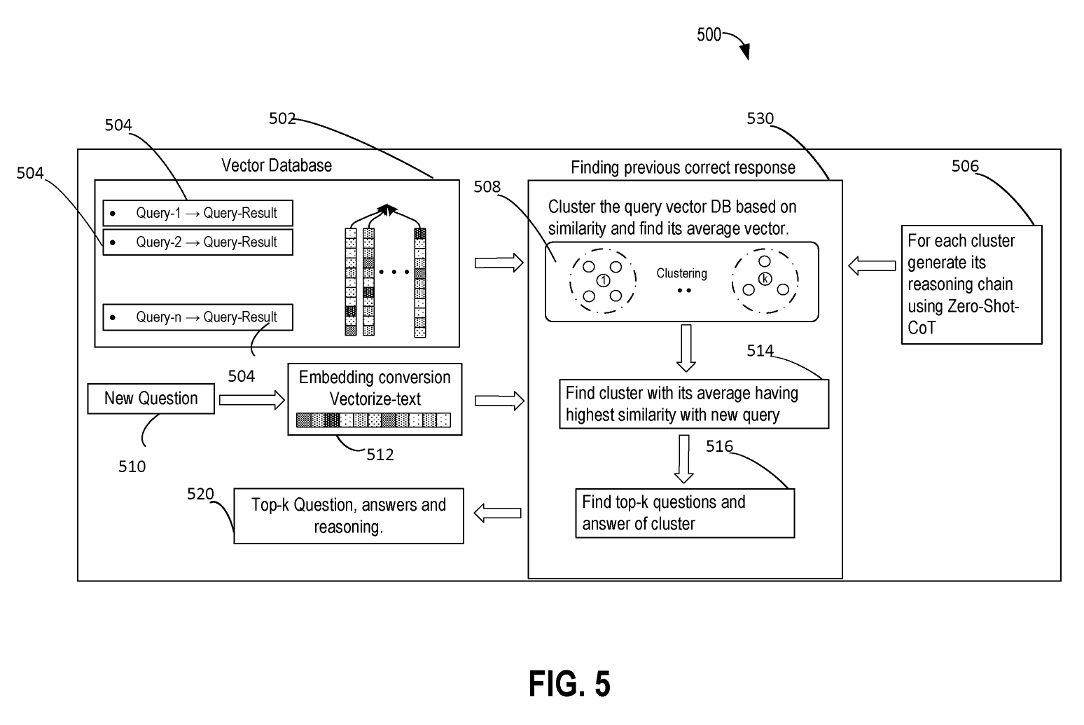

In some embodiments, the nodes (e.g., node(s) 204) and associated edges (e.g., edge(s) 202) can be an input and/or training data into a machine learning (ML) model. According to some embodiments, at least one graph (e.g., graph 200) can be used as training data. In some embodiments, the system (e.g., system 100) can, through the one or more processors, receive training data that represents one or more graphs (e.g., graph 200) which include a plurality of nodes (e.g., node(s) 204) and a plurality of edges (e.g., edge(s) 202.) Additionally, a ML model can be trained by providing it with a smartly generated concise context of the graph, which may include all unique information (e.g., nodes 204, edges 202, etc.) about the graph (e.g., graph 200), as shown in FIGS. 5, 6, and 7. That is, a ML model can understand the whole context of the graph (e.g., graph 200) without actually being fed the complete graph, in some implementations. In some embodiments, the graph 200 can be stored by the database 155 and used by system 100. To do this, the graph 200 can be populated with a multitude of nodes 204, edges 202, and relationships 206 to be clustered, filtered, fetched, loaded, or otherwise used. In some embodiments, graphs or portions thereof can represent hierarchical relationships and can be used as training data.

In some embodiments, the nodes 204 can be representations of subjects or objects. For example, the nodes 204 can represent entities, events, and/or concepts. In some embodiments, the nodes 204 can be defined according to a key (e.g., schema, ontology, etc.). That is, nodes 204 can represent different types of entities, devices, locations, points, persons, policies, and software services (e.g., API services). For example, nodes 204 can represent physical spaces, mechanical equipment, sensors and actuators, network devices, logical zones, structural elements, and any other relevant physical, metaphysical, or digital entity to be populated in a graph. Additionally, nodes 204 can be clustered by relationships (e.g., relationships 206), such as hierarchal or weighted relationships. For example, the hierarchal or weighted relationships can be a combination of any attribute of the node. In some embodiments, nodes 204 are clustered based on the attributes of a node having a stronger relationship to neighboring nodes. In some embodiments, a plurality of nodes and corresponding hierarchy can be defined as portions, or relationship clusters. Relationship clusters can include groups of nodes sharing common attributes, edge relationships, interactions, etc. For example, a relationship cluster can represent a group of nodes for structural elements, such as one or more nodes for beams, columns, and walls that share physical support relationships. In another example, a relationship cluster can include components of a mechanical system, including nodes for HVAC units, pipes, and ducts linked by edges containing functional dependencies, spatial proximity, etc. In some embodiments, the graph 200 includes edges 202. In some embodiments, the edges (e.g., edge 202) can represent the relationships (e.g., relationship 206) between entities and/or events (e.g., nodes 204). That is, edges (e.g., edge(s) 202) can represent predicates in a graph (e.g., graph 200, RDF graph, etc.). For example, a predicate can describe the nature of the relationship between a subject node and an object node. For example, an edge 202 can have a predicate with the relationship “isLocatedIn”, or “isFedBy”, noting the relationship between a subject node and an object node. In some embodiments, edges can represent a type of node (e.g., alias, itemReference, building type, location, floor, room, space, equipment, etc.).

In some embodiments, edges 202 may have directional input. For example, an edge 202 may contain a direction and/or a directional weight. For example, an edge 202 connecting a first node and a second node may have a first directional weight going from the first node to the second node. In another example, an edge 202 connecting a first node and a second node may have a second directional weight going from the second node to the first node. In some embodiments, an edge (e.g., edge(s) 202) containing a direction and/or directional weight between nodes (e.g., node(s) 204) can allow for efficient mapping and data usage for system 100. In some embodiments, efficient mapping and/or clustering of nodes can allow for less input of the entire graph into a ML model.

FIG. 3 depicts a selection of different nodes in an RDF graph, according to an example embodiment. The selection of nodes can be used by at least one of the various systems described herein. In some embodiments, a selection of nodes can include nodes 204. In some embodiments, nodes 204 are used to populate an RDF graph. For example, a database (e.g., database 155) can include a plurality of nodes (e.g., nodes 204). In some embodiments, nodes 204 can represent entities. For example, nodes can represent entities of a building (e.g., building 10) and/or equipment (e.g., equipment 130). In some embodiments, nodes can represent points, locations, systems, relationship nodes, among others.

According to some embodiments, nodes 204 can include at least one subject and/or at least one object. For example, a subject can include a descriptor of a node 204. In some embodiments, a node 204 can contain a value for a subject. That is, if a node 204 contains a subject, there can be a value attached within the node for that subject. For example, a node 204 can relate to an AHU located in a building on floor 15 and can contain a value for the subject floor 15. In some instances, the value can be positive if the node contains the subject. In some instances, the value can be negative if the node does not contain the subject. According to some embodiments, the value can be zero if the node does not contain the subject.

According to some embodiments, nodes 204 can represent various entities and their relationships within the graph (e.g., Brick schema relationships). For example, node 204(a) is shown to contain the non-limiting example of node subjects of Object, Floor, Location and/or other subjects. These objects can be descriptors for building subjects for digestion of the node. For example, node 204(a) can have attached values for every node subject in the system. The values can be binary, numerical, categorical, string values, enumerated values, etc. to show whether the node in question contains the building subjects. In some embodiments, the nodes (e.g., node 204(a)) may only contain the subjects that have a positive relation to the node (e.g., a node representing an air duct in a building would contain the subject node (e.g., Building) for that building and potentially a value for the subject but may not contain the subject for Floor as there is no relationship between the air duct and any floor in the building).

According to some embodiments, nodes 204 can become clustered based on an aggregate of values and/or subjects. According to some embodiments, an RDF graph can contain hundreds of thousands of nodes, each containing at least one descriptor, subject, object, edges (e.g., edges 202), and/or relationships (e.g., relationships 206), as shown in FIG. 3. In some embodiments, clustering nodes can provide for queryable portions within the graphs.

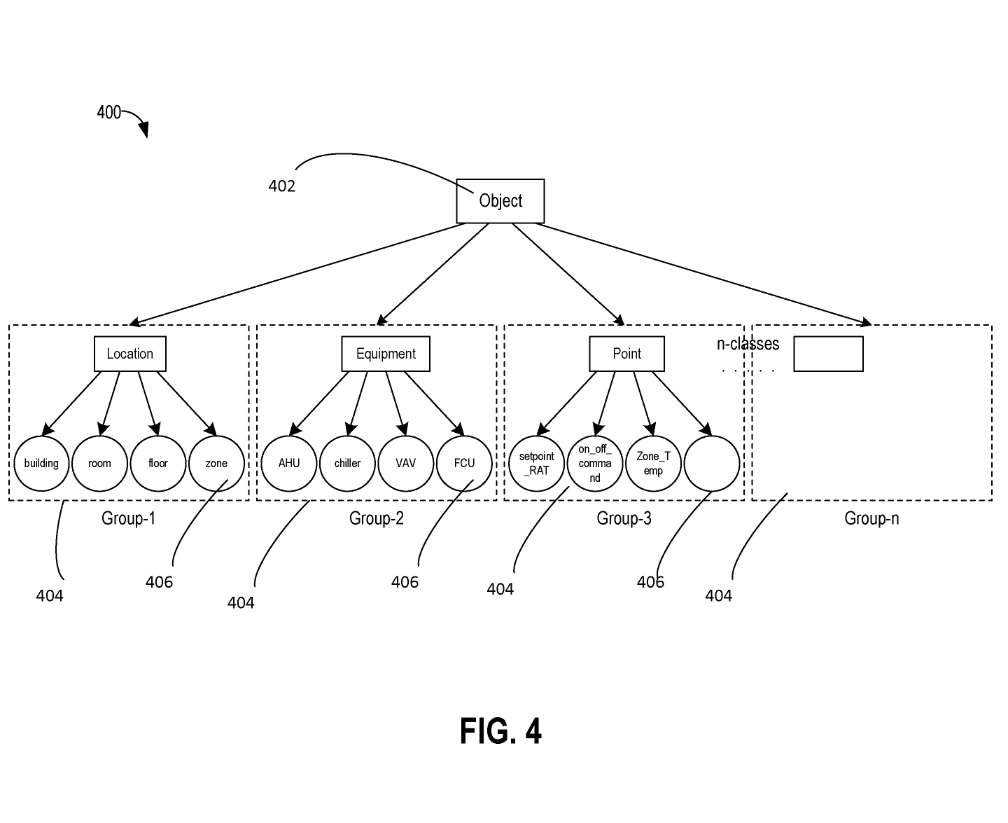

FIG. 4 depicts group creation 400 in a subject-type node digest, according to an exemplary embodiment. In some embodiments, class creation can used to describe and group nodes (e.g., nodes 204) by class type. According to some embodiments, group creation 400 can include a list of a number of node classes (e.g., general node class 402, parent node class 404, node class type 406) that exist. Group creation 400 can be used by the system 100 and any of the components of system 100 in generating a digest to include the groups. In some embodiments, the digest can be used to train the LLM. In some embodiments, group creation 400 can be used in a graph to cluster information from a database (e.g., database 155), as discussed in FIGS. 5, 6, and 7. In some embodiments, group creation 400 allows for selections of information and relationships within a digital twin to be sent to a LLM without the entire graph needed to be sent. For example, the system can train the LLM to process of a context of a building graph. That is, the context can be one or more relationship clusters including extractions of portions of the building graphs, or groups generated by group creation 400.

According to some embodiments, group creation 400 can include a hierarchy of node classes. In some embodiments, class creation can be based on subject-type node digestion. For example, group creation 400 can include a general node class (e.g., general node class 402). In some embodiments, general node class 402 can be a structure used to encapsulate at least one other node class (e.g., parent node class 404, node class type 406). For example, a general node class 402 can contain all the node classes used in a graph (e.g., graph 200). For example, general node class 402 is shown to be labeled as “Object”. Object can represent a subject node that represents an entire building, building system, or any system, component, equipment or other object within. Within a building system, there can be a magnitude of groupings divided by further node classes (e.g., general node class 402, parent node class 404, node class type 406).

According to some embodiments, group creation 400 can include a parent node class 404. In some implementations, a parent node class 404 can group related node class types (node class types 406). As discussed earlier, a node (e.g., node 204) can contain and/or represent subjects and/or objects. In some embodiments, the subjects and/or objects can be further represented as a parent node class 404. For example, one of the parent node classes 404 shown in FIG. 4 is Location. This parent node class can be used as a subject for nodes within the overarching system. Some parent node classes can include, as a further examples and a non-exhausting list, Equipment, Point, Controller, Supply, Fan, Object, etc.

According to some embodiments, group creation 400 can include a grouping of a node class type 406. A node class type 406 can be a class type under a parent node class type (e.g., parent node class 404). For example, one of the parent node classes 404 showing in FIG. 4 is Location. FIG. 4 depicts parent node class 404 of Location as having node class types of building, room, floor, and zone. In some embodiments, this structure is to show, for example, that building can represent a building for which a piece of equipment may be included in. For example, a heating unit can be the object node or general node class (e.g., general node class 402). The heating unit can contain a parent node class e.g., parent node class 404) of Location. The heating unit can have a value representing its value for the parent node class for Location. Further, the parent node class Location can contain the node class types of building, room, floor, and zone. The heating unit may have a value of 1 for node class type building, denoting that the particular heating unit is located in building 1. Additionally, the heating unit may have a value of 24A for node class type room, denoting that the particular heating unit is located in/near/connected to etc. in room 24A. In some embodiments, node class types 406 and parent node classes 404 used to place a node into particular groups, create relationships with other nodes, or cluster on a graph, as discussed in the various embodiments herein.

FIG. 5 depicts a self-improvement framework 500, according to an exemplary embodiment. In some embodiments, the self-improvement framework 500 can be a self-improvement framework for the building management system of FIG. 1 (e.g., executed by graph management system 105). Self-improvement framework 500 can be executed by any of the systems described herein. In some embodiments, self-improvement framework 500 can be used to improve prompt creation for generating prompts to an LLM. That is, reasoning produced by the self-improvement framework 500 can be used as input for prompt generation for a model to generate a graph query. In some embodiments, the self-improvement framework 500 can include a vector database 502, query structures 504, cluster reasoning generation module 506, clustering module 508, question 510, vectorized embeddings 512, cluster selection module 514, retrieval module 516, reasoning 520, and/or response model 530. In some embodiments, self-improvement framework 500 can store user input queries, model queries, and responses, and perform vector search for finding queries and responses which are similar to a question or query (e.g., input query 706).

In some embodiments, the graph management system 105 can execute the self-improvement framework 500 to self-improve over time by feeding reasoning and rating to saved responses. For example, the graph management system 105 can leverage feedback loops where newly generated responses are compared against previously stored responses based on a set of evaluation metrics, including accuracy, relevance, and/or logical consistency. In some embodiments, the graph management system 105 can feed reasoning through automated reasoning engines that analyze the logical structure of past responses and validate them against predefined rules or ontologies (e.g., Brick schema). The graph management system 105 can rate reasoning by applying machine learning models to assess response coherence, similarity scoring techniques to compare with high-confidence responses, and reinforcement learning methods where user interactions (e.g., confirmations, corrections) provide implicit feedback.

In some embodiments, the graph management system 105 can use the ratings generated by the self-improvement framework 500 to produce relevant examples and reasoning. In some embodiments, the graph management system 105 can execute the self-improvement framework 500 in conjunction with a manual rater and feeder to find a most relevant example and its highest rated answer. That is, the graph management system 105 can cross-reference user-validated responses with system-generated reasoning through the self-improvement framework 500. The manual rater can override automated scoring when necessary, allowing the graph management system 105 to continuously refine its knowledge base with contextually accurate responses.

In some embodiments, the graph management system 105 can use the reasoning as input to improve prompt creation for generating prompts as input for a model to generate a graph query. For example, when a user submits a query about retrieving all temperature sensors connected to an HVAC system, the graph management system 105 can execute the self-improvement framework 500 to analyze past similar queries, corresponding graph queries, and/or effectiveness in retrieving accurate results. The graph management system 105 can combine the user query with relevant examples and high-rated reasoning to refine the prompt by incorporating additional context (e.g., specifying sensor type, filtering by location, including metadata tags, etc.) and digest information.

In some embodiments, the graph management system 105 can store input queries in a vector database 502. That is, the graph management system 105 can maintain the vector database 502 to store and manage high-dimensional data vectors. The vector database 502 can include query structures 504. In some embodiments, query structures 504 can include pairs of queries and query-results. In some embodiments, the graph management system 105 can convert query structures 504 into vectors by generating vector embeddings and storing the vector embeddings within a vector storage and similar search database (e.g., vector database 502). In some embodiments, the graph management system 105 can convert a question 510 into a vector. For example, the graph management system 105 can provide the natural language text (e.g., question 510) to an embedding model to convert the natural language text into indexable vectors (e.g., vectorized text embedding 512) that can be utilized by the machine learning models described herein. The graph management system 105 can apply the natural language prompts (and/or one or more tokens thereof as generated by a tokenizer, such as a byte pair encoding tokenizer, etc.) as input to the embedding model to cause the embedding model to generate respective vectors representing the natural language prompts in an n-dimensional space. The embedding model can include any of various functions, algorithms, rules, and/or machine learning models configured to generate vectors representative of text or semantic data, including but not limited to models such as convolutional neural networks (CNNs), word2vec, or Bidirectional Encoder Representations from Transformers (BERT).

In some embodiments, the graph management system 105 can convert a question 510 (e.g., an input query) into a vector. For example, the graph management system 105 can receive a question asking which rooms in a building are above a threshold temperature of 75 degrees and break down, embed, and/or convert the question into a vector. For example, the graph management system 105 can use tokenization to break down the question into individual tokens comprising words or subwords. The graph management system 105 can normalize, embed, link to an entity, concatenate, and transform the tokens into vectorized text for use by the response model 530 (e.g., previous correct response finding framework for determining correct response).

In some embodiments, the graph management system 105 can provide contextualized vectors (e.g., vectors from the vector database 502, vectorized text embedding 512, etc.) as input for the response model 530. In some embodiments, the graph management system 105 can average the contextualized vectors to form a fixed-size question representation. As shown in FIG. 5, the response model 530 can include a clustering module 508, a highest-similarity cluster selection module 514, and/or a top-k question-and-answer retrieval module 516. The response model 530 can provide the self-improvement framework 500 with filtering for the highest quality output.

As shown in FIG. 5, the response model 530 can include the clustering module 508. In some embodiments, the graph management system 105 can execute the clustering module 508 to cluster portions of the vector database 502. In some embodiments, the graph management system 105 can perform clustering based on similarity of data (e.g., nodes, edges, relationships, etc.). In some embodiments, the graph management system 105 can generate an average vector for each cluster through the clustering module 508. When the graph management system 105 generates a cluster, the graph management system 105 can generate a reasoning chain (e.g., via the cluster reasoning generation module 506). Any model described herein can be used by the graph management system 105 to generate the reasoning chain through the cluster reasoning generation module 506. For example, the graph management system 105 can use a ML model to generate a reasoning chain for a cluster by providing a prompt such as "explain step by step how this cluster was created and is related, including the top questions, answers, and solutions relevant to this cluster in comparison to the new question 510." The graph management system 105 can apply chain of thought (CoT) reasoning within the self-improvement framework. For example, example-based CoT (Ex-COT) or Zero-Shot-CoT reasoning can be developed for a graph query. In some embodiments, the graph management system 105 can adapt reasoning from previous answers to similar queries and provide the adapted reasoning as an example to an LLM. That is, the graph management system 105 can use the cluster reasoning generation module 506 to improve performance over time and provide mechanisms to control the quality and direction of output by manual intervention from time to time.

As shown in FIG. 5, once the graph management system 105 generates clusters via the clustering module 508, the graph management system 105 can execute the highest-similarity cluster selection module 514 to identify at least one cluster with an average having the highest similarity with at least one query. In some embodiments, the graph management system 105 can compare a vector (e.g., vectorized text embedding 512) to a plurality of generated clusters. For example, the graph management system 105 can convert the question "what rooms does HVAC system 1 connect to?" into a vector and compare the vector to generated clusters of the vector database. The graph management system 105 can execute the highest-similarity cluster selection module 514 to identify which cluster or clusters have a relationship to the question vector above a certain threshold. For example, the highest-similarity cluster selection module 514 can identify at least one cluster of questions related to HVAC systems. In some embodiments, the graph management system 105 can execute the top-k question-and-answer retrieval module 516 of the response model 530. In some embodiments, the top-k question-and-answer retrieval module 516 can produce a plurality of top questions and a plurality of top answers from the identified cluster.

In some embodiments, the graph management system 105 can sort cluster data, such as questions and answers, in comparison to the distance to the center of the cluster. In some embodiments, the graph management system 105 can further filter results through the response model 530 to produce an output (e.g., top-k question answers and reasoning 520). In some embodiments, the top-k question answers and reasoning 520 can include at least one top question, at least one top answer, and at least one reasoning. In some embodiments, the at least one top question can include a query from the vector database 502. In some embodiments, the graph management system 105 can use the top-k question answers and reasoning 520 as input for generating a prompt for a model or for training a model (e.g., model 714). In some embodiments, the graph management system 105 can use the top-k question answers and reasoning 520 to generate a prompt (e.g., at prompt creation 712). In some embodiments, the graph management system 105 can execute the self-improvement framework 500 with, parallel to, or otherwise in conjunction with a natural language query on a specified schema (e.g., system 700).

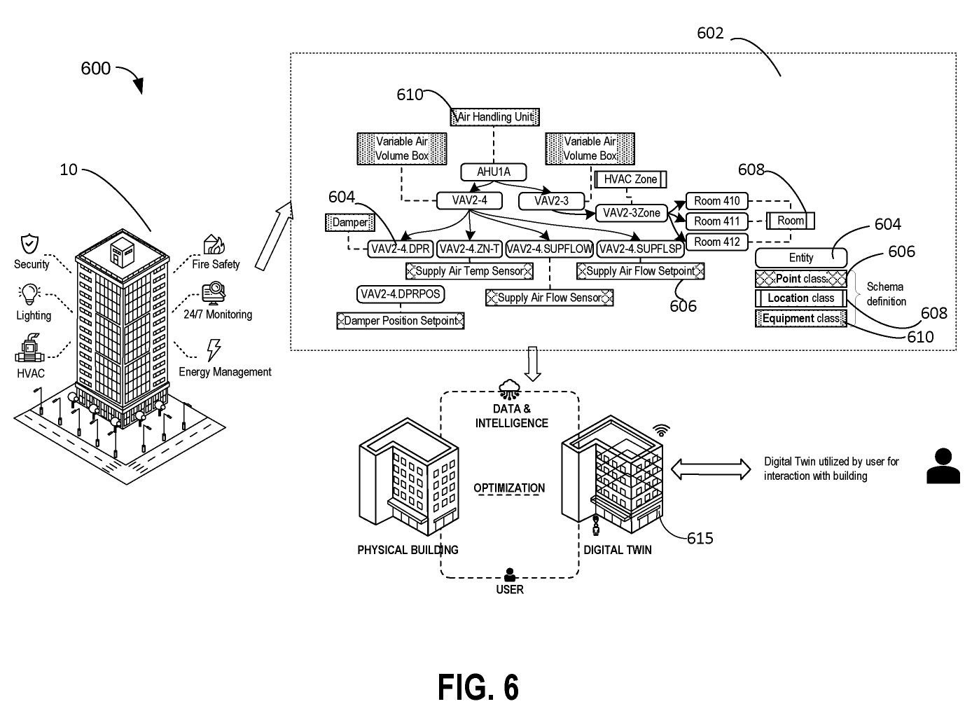

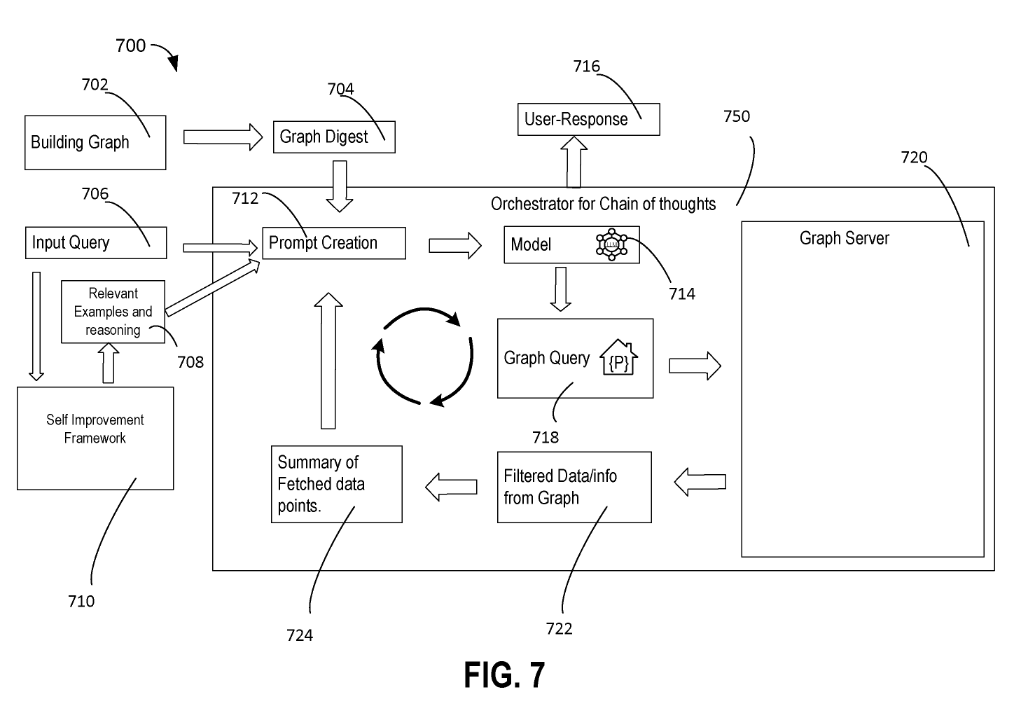

FIG. 6 depicts a digitization workflow 600 of creation of a digital twin, according to an exemplary embodiment. For example, one or more processors (e.g., of the graph management system 105) can execute any of the components of the digitization workflow 600. In some embodiments, the digitization workflow 600 can include a building 10, graph 602, entity 604, point class 606, location class 608, equipment class 610, and digital twin 615. Digitization workflow 600 illustrates how a digital twin 615 is created and utilized by a user for interaction with a building (e.g., building 10). In some embodiments, digitization workflow 600, through the one or more processors, can gather data from various buildings or building systems (e.g., building 10) as described in FIGS. 1-4. In some embodiments, digitization workflow 600 can clean and format building data for consistency and accuracy. In some embodiments, the graph management system 105 use the workflow 600 to establish connections between different data points. In some embodiments, the graph management system 105 can organize, summarize, and group nodes for processing and/or retrieval using workflow 600. In some embodiments, the digitization workflow 600 can be used in conjunction with a model. For example, the digitization workflow 600 and parts within (e.g., graph 602) can be an input into system 700 as the building graph 702 and graph digest 704. In another example, the digitization workflow 600 and parts within (e.g., graph 602) can be traversed by a query, such as a query generated by a model, as explained in FIG. 7.

In some embodiments, the one or more processors (e.g., processor 115) can convert the building data into a graph 602. The graph 602 can be a building graph processed, by the one or more processors 115, into RDF format by the systems described herein. In some embodiments the graph 602 is a Brick schema graph or other schema or ontology graph. In some embodiments, the graph 602 can be used to generate prompts as discussed in FIG. 7. In some embodiments, the system 100 can generate a graph digest comprising one or more relationship clusters within the one or more building graphs. In some embodiments, the system 100 can train a LLM to process a context of the one or more building graphs such that the LLM is configured to generate graph queries to traverse given portions of the plurality of portions. In some embodiments, the graph queries can be configured to retrieve corresponding information from the given portions. In some embodiments, the graph 602 can be queryable. The graph 602 can include nodes and edges as described in FIGS. 1-4.

In some embodiments, graph 602 can include at least one entity 604, at least one point class 606, at least one location class 608, and/or at least one equipment class 610. In some embodiments, entity 604 can represent any physical, logical, or virtual entity within a building. In some embodiments, the entity 604 can be a brick entity of a brick schema graph. In some embodiments, entity 604 can include a VAV system, AHU system, rooms, etc. In some embodiments, graph 602 can include at least one point class 606. In some embodiments, point class 606 can identify specific data points related to building systems. For example, the point class 606 can relate to sensors, actuators, setpoints, and other devices that monitor or control various aspects of the building’s environment. In some embodiments, graph 602 can include at least one location class 608. In some embodiments, location class 608 can represent the physical or logical spaces in a building (e.g., building 10). For example, location class 608 can indicate a room, floor, zone, building, site, campus, or any other location class included in a building. In some embodiments, graph 602 can include at least one equipment class 610. In some embodiments, equipment class 610 can represent various types of equipment found in a building. For example, equipment class 610 can include HVAC equipment, AHU, VAV boxes, lighting equipment, plumbing equipment, electrical equipment, security equipment, or any other type of equipment relating to a building (e.g., building 10). In some embodiments, digitization workflow 600 can include a digital twin 615. According to some embodiments, a digital twin can be generated, by the one or more processors. by a graph 602 (e.g., Brick schema graph) to represent a building (e.g., building 10). For example, the digital model can mirror the real-world building, capturing its structure, systems, and operations in a digital format. In some embodiments, digital twin 615 provides for real-time data integration, simulation, analysis, visualization, predictive maintenance, and other utilities. In some embodiments, the digital twin 615 can be queryable. For example, a digital twin can be loaded and queried by the one or more processors discussed herein.

FIG. 7 depicts an example system 700 for a system (e.g., any of the systems described herein) for retrieving information to provide a user response to an input query. The system 700 can include an orchestrator 750 for retrieving the information. The system 700 can include a training process for a machine learning model for retrieving information from a building management system, and a related user query and self-improvement framework discussed above, with respect to FIG. 5. As illustrated, the training process includes generating prompts at prompt creation 712. Prompt creation 712 can generate prompts by retrieving at least one of at least a portion of the graph digest of the building graphs (e.g., building graph 702, graph digest 704), an input query 706, and/or relevant examples and reasoning 708. Intelligent prompt creation (e.g., prompt creation 712) allows orchestrator 750 to complete steps (receiving, training, modeling, querying, accessing, determining, filtering, summarizing) in creating a completion summary (e.g., summary 724) through the orchestration process that can be repeated in the orchestration process. In some embodiments, at least one of the various systems described herein may perform at least one step and/or operation of the system 700. For example, the graph management system 105 may perform at least one step of the system 700 or include at least one component of the system 700. The system 700 can be performed using various devices and systems described herein, including but not limited to the system 100. Various aspects of the system 700 can use one or more devices or systems that are communicatively coupled with one another, including in client-server, cloud-based, or other networked architectures. For example, the graph server 720 can be stored on a cloud based graph engine to limit data usage by the system.

As described with respect to various aspects of the system 100, the system 700 can implement operations to facilitate accurate, precise, and/or timely determination completion to prompts from users regarding a variety of assets or entities associated with a building. Additionally, the more or more processors (e.g., processor 115) described herein may perform at least one step of the system 700. While several steps and/or operations of the system 700 may be described as being performed by a given system, device, and/or component, the system 700 and/or portions thereof may be performed by one or more systems, devices, and/or components. Additionally and/or alternatively, one or more steps of the system 700 may be combined, separated, omitted, skipped, repeated, replicated, or otherwise altered. According to some embodiments, FIG. 7 can include steps that include at least a building graph 702, graph digest 704, input query 706, relevant examples and reasoning 708, self-improvement framework 710, prompt creation 712, model 714, user-response 716, graph query 718, graph server 720, filtered data 722, and/or summary 724 and/or orchestrator 750.

In some embodiments, the system 700 can generate a prompt based on one or more aspects of the graph digest 704 and one or more aspects of the input query 706. For example, the system 700 can generate a prompt based on determining one or more relationship clusters corresponding to the input query 706. For example, the system 700 can determine the input query is related to power unit A. System 700 can determine one or more clusters relating to power unit A and generate a prompt based on the input query and clusters to provide as input to the model 714. For example, the system 700 can use the natural language input query and clusters relating to power unit A to generate a prompt directing the model to generate a SQL query for traverse the graph to access graph data regarding power unit A. Additionally, the system 700 can generate graph queries and responses corresponding to the accessed data for output (e.g., user-response 716) and/or for prompt creation training. For example, the system 700 can generate a natural language response based on the executed query. The natural language response can be used for prompt creation. For example, the system 700 can generate a prompt based on one or aspects of input queries, one or more aspects of a graph digest, and one or more aspects of executed queries (e.g., summary 724, retrieved first set of information).

In some embodiments, the system 700 can traverse a given portion of the building graph based on the graph query and retrieve corresponding information from the given portions. For example, a graph query 718 directed to explaining the relationships of the heating system of the building can traverse a given portion of the building graph to retrieve corresponding information from the given portions. The system 700 can generate a summary (e.g., summary 724) of the traversed portion of the building graph based on the retrieved corresponding information. For example, the system 700 can generate a summary including information about the heating system’s components, such as boilers, radiators, and thermostats in addition to the respective interconnections and operational status. The summary can be used to determine an additional prompt for generating a new graph query. For example, the summary of the first graph query can include details about the efficiency of the heating system and detected anomalies. The summary, combined with an input query about optimizing energy usage, and the context provided by the graph digest, can be used to generate a new prompt for the model 714 to create a graph query focused on energy information and performance of the heating system. That is, the process can be iterated until the graph query 718 produces filtered data that the system 700 can determine to satisfy the requested information of the input query.

Additionally, the system 700 can transmit an electronic message to the computing device to provide the first set of information. That is, the system 700 can transmit a message responsive to execution of the prompt. For example, the system can transmit an electronic message to a computing device. That is, the system 700 can transmit an electronic message to a user device corresponding to response of the input query. For example, the message can include a graph, chart, natural language, and/or other messages regarding the input query.

System 700 can include a building graph 702. According to some embodiments, the building graph 702 can be implemented as any of the systems described herein, including but not limited to graph 200. For example, the building graph 702 can be implemented as a Brick ontology graph. In some embodiments, the one or more processors can receive data from the building graph 702. For example, the building graph 702 can include nodes and edges. That is, the building graph can include a plurality of nodes, wherein the nodes can include entities (e.g., building entities) as discussed throughout herein. In some embodiments, the building graph 702 can include a plurality of edges, wherein the edges can include relationships. In some embodiments, the building graph 702 can include \a plurality of portions within the one or more building graphs for which data is queryable. In some embodiments, the building graph 702 can include a portion of a building graph. For example, the building graph 702 can include a selection of clusters.

System 700 can include a graph digest 704. In some embodiments, the one or more processors may generate a graph digest (e.g., graph digest 704) from the loaded building graph (e.g., building graph 702) or selection of building graph. For example, the one or more processors can generate a graph digest including one or more relationship clusters within a building graph, the relationship clusters including extractions of a plurality of portions of the building graph, such as discussed in relation to the graphs and components discussed with respect to FIGS. 2-4. In some embodiments, the graph digest 704 may be a summary or selection of graph nodes, edges, properties, and/or relationships. In some embodiments, the graph digest 704 can be implemented as any of the systems described herein. For example, the graph management system 105 may identify a selection of a database (e.g., database 155) for the graph digest. For example, the graph digest 704 may include all the unique information about the graph. In some embodiments, the one or more processors can automate a procedure or creating the graph digest 704. In some embodiments, the graph digest 704 can be used as input to prompt creation 712.

System 700 may include an input query 706. In some embodiments, the one or more processors may generate a query by any of the systems described herein. In some embodiments, the input query 706 may be user generated. In some embodiments, the input query 706 may be executed by one or more processors. In some implementations, the input query 706 may be a request for information. For example, the input query 706 may be a request for building information or building processes. In some embodiments, the input query 706 can include a request for information within and/or an analysis of the building graph and/or a selection of the building graph.

In some embodiments, the input query 706 can include a request for information associated with one or more aspects of a second building. Additionally, the input query 706 can include a request for information relating a first system to a second system. In some embodiments, the input query 706 can include a request for information relating a first building and/or systems within to a second building and/or systems within. In some embodiments, the input query 706 can include a request for instructions. For example, the input query 706 could include a request to find the connections of an HVAC system within a building, where and/or how they are connected, and/or instructions on how to fix any connection. In some embodiments, input query 706 can be input for other components of the system 700, such as prompt creation 712 or self-improvement framework 710.

System 700 may include relevant examples and reasoning 708. In some embodiments, relevant examples and reasoning 708 can be generated by self-improvement framework 710. In some embodiments, relevant examples and reasoning 708 can include or correspond to reasoning 520, as discussed in relation to FIG. 5. For example, relevant examples and reasoning can include the top question, answer, and reasoning for a stored input query or cluster or stored input queries, which can be used as input for prompt generation or context for model 714 to generate a graph query 718. In some embodiments, the one or more processors may generate relevant examples and reasoning 708. In some embodiments, relevant examples and reasoning 708 can be implemented by any system described herein. In some embodiments, relevant examples and reasoning 708 can be held in memory. In some embodiments, relevant examples and reasoning 708 can be generated from a graph. For example, relevant examples and reasoning 708 can be stored in a database. That is, the database can hold relevant examples and reasoning related to a second building.

In some embodiments, relevant examples and reasoning 708 can relate to queries (e.g., input queries 706). For example, relevant examples and reasoning 708 can be an accumulation and distribution of previous queries and responses. That is, relevant examples and reasoning 708 can include instructions relating to building equipment and data. For example, relevant examples and reasoning 708 could include instructions for maintaining an equipment cycle (e.g., an equipment startup, an equipment shutdown). In some embodiments, relevant data, and reasoning 708 can include a set of actions to perform (e.g., control the equipment) the equipment cycle. In some embodiments, relevant examples and reasoning can include an example and reasoning for equipment relationships, sensor data, control logic, fault detection and diagnostics, energy optimization, predictive maintenance, and/or space utilization, among other examples and reasoning. In some embodiments, relevant examples and reasoning 708 can be previous outputs of a workflow (e.g., system 700). Additionally, relevant examples and reasoning 708 can be an input for prompt creation (e.g., prompt creation 712).

System 700 is shown to include self-improvement framework 710. The one or more processors can execute self-improvement framework 710. In some embodiments, the self-improvement framework 710 can be similar to or implemented as self-improvement framework 500. Self-improvement framework 710 can interact with any of the systems or processes herein. In some embodiments, self-improvement framework 710 can focus on enhancing the system’s performance over time through iterative learning and feedback. For example, by using previous queries (e.g., input query 706) and responses (e.g., summary 724, reasoning 520) In some embodiments, self-improvement framework 710 can include and/or incorporate example-based reasoning. In some embodiments, users can provide feedback for the system responses, identifying areas for improvement. For example, a user could provide feedback that they were asking for a summary of the equipment that have portions in a room A and a room B when the system provided a summary of equipment that are in room A or room B, but not having portions in both. By incorporating knowledge based updates, self-improvement framework 710 can use previous responses (e.g., relevant examples and reasoning 708, queries, summaries 724, etc.) as a single shot learning mechanism for a process (e.g., cycle within orchestrator 750, model 714, etc.).

System 700 is shown to include orchestrator 750. The one or more processors described herein can execute any or all functions of the orchestrator 750. In some embodiments, orchestrator 750 can provide for an iterative approach to retrieve information from a graph and traverse the depth of the graph to get to desired points in response to a query. For example, orchestrator 750 can provide for a response to a query by travelling from overall building context to individual sensor levels using its components. In some embodiments, orchestrator 750 can have components prompt creation 712, model 714, graph query 718, graph server 720, filtered data 722, and/or summary 724. In some embodiments, the one or more processors can execute the orchestrator 750 and components within. In some embodiments, the steps performed by orchestrator 750 can be repeated until an answer to user query is filtered. For example, the one or more processors can update the model 714 using any of the information generated or received during any step of Orchestrator 750. Orchestrator 750 can, through the one or more processors, receive and/or transmit from and/or to any computing device or system described herein, electronic messages. Electronic messages can include any of the information or steps described herein, (e.g., prompts, queries, buildings, databases, graphs, portions of graphs, digests, reasoning, digests, relationships, examples, summaries, reasonings).

In some embodiments, orchestrator 750 can receive data representing one or more graphs (e.g., building graph 702, graph digest 704). For example, the orchestrator can receive data that includes a portion of building data (e.g., graph digest 704). In some embodiments, the orchestrator can use the data to train a model (e.g., model 714, ML model, LLM, etc.) to process a context of the one or more graphs such that the model is configured to generate queries (e.g., graph query 718). In some embodiments, the queries can be used for traversing given portions of the plurality of portions to retrieve corresponding information from the given portions. For example, a query could be used to traverse of portion of a graph containing all HVAC information of a building in order to find which HVAC units may require maintenance due to readings of their sensor data.

In some embodiments, orchestrator 750 can receive an electronic message that includes an input query 706. In some embodiments, the input query can be for a first set of information associated with one or more aspects of a second building. In some embodiments, orchestrator 750, through the one or more processors, can determine, based on at least the one or more aspects of the intent of the input query 706 and generate a prompt (e.g., prompt creation 712). As an example, the system 700 can receive an input query 706 for receiving information related to a specific VAV. In some embodiments, the orchestrator 750 can use the input query 706 to generate a prompt for the model 714 to generate a graph query 718 to traverse a graph with graph server 720 and output a user-response 716 in natural language format. For example, orchestrator 750 can receive an input query 706 and generate a prompt related to retrieving information for a specific VAV. If a given entity within the building knowledge graph has a first node or edge that reads, for example, “b:V1 rdf:type brick:VAV” in its raw format and a second node or edge that reads, for example, “b:V1 brick:hasPoint b:ZNT1” in its raw format, a natural language response (e.g., user-response 716) can be generated for the entity (e.g., V1) that pulls the entity type from the first node or edge (e.g., VAV) and pulls a relationship with another entity from the second node or edge (e.g., V1 has a point ZNT1) to form a natural language sentence in the form of “V1 is a VAV and has a point ZNT1.”

In some implementations, the type, properties, and relationships associated with an entity can be combined into a single natural language prompt (e.g., a description in the form of a long sentence) describing the entity, its type, its relationships, and its various properties. For example, orchestrator 750 can receive a graph digest 704, input query 706, relevant examples and reasoning 708, and a summary 724 to generate a prompt to give as input to model 714. For example, if a single entity is related to a plurality of other entities in a similar way, the natural language sentence or paragraph generated can combine or otherwise simplify the relationships. For example, instead of repeating “X is a point of Y and X is a point of Z,” the generated sentence or paragraph can include “X is a point of Y and Z.” In some implementations, the generated natural language description can further ensure proper casing (e.g., representing the data from the knowledge graph with accurate uppercase and/or lowercase features) such that, for example, “X rdf:type brick:VAV” becomes “X is a VAV,” but “X rdf:type Temperature_Sensor” becomes “X is a temperature sensor.”

In some implementations, nodes or edges in their raw format can be translated into the natural language prompts for the various entities manually by a user via a user interface, using a translation application or program specifically configured to translate a given ontology schema into natural language prompts, and/or using one or more artificial intelligence models (e.g., one or more of the artificial intelligence models described herein). For example, one or more contextual rules for translating the raw format nodes and edges into natural language prompts can be provided as inputs to train one or more artificial intelligence models to allow for the artificial intelligence models to be used to autonomously translate raw format (e.g., BRICK or other ontology schema) nodes and edges into natural language prompts, as discussed above. Accordingly, in some instances, the entire building knowledge graph may be translated into natural language text using one or more of the machine learning models described herein.

In some embodiments, orchestrator 750, can provide, as one or more inputs, the prompt (e.g., prompt creation 712) to the model to cause the model to generate a graph query (e.g., graph query 718) for a building graph (e.g., building graph server 720). In some embodiments, the query can be configured to traverse a portion of the building graph based on the given portion corresponding to the one or more aspects of the first or second building. In some embodiments, the orchestrator 750 can transmit, responsive to the execution of the query, a second electronic message to the computing device to provide the first set of information.

System 700 and orchestrator 750 are shown to include prompt creation 712. The one or more processors of the system can execute prompt creation 712. In some embodiments, prompt creation 712 can involve designing specific instructions that guide an AI model (e.g., model 714) to generate a desired output. In some embodiments, prompt creation 712 can outline instructions for a model to achieve a result. For example, prompt creation can include generating text, answering questions, creating images, etc. In some embodiments, prompt creation 712 includes gathering data. For example, data gathering for prompt creation can include collection data from a graph (e.g., graph 200, building graph 702), a graph digest (e.g., graph digest 704), queries (e.g., input query 706), past workflow output, and/or other data (e.g., relevant examples and reasoning 708, summary 724).

In some embodiments, prompt creation 712 can generate a prompt. For example, a prompt can include specific instructions for a model (e.g., model 714). That is, a prompt can include a request for information relating to building information, equipment, equipment relationships, sensor data, control logic, fault detection and diagnostics, energy optimization, predictive maintenance, and/or space utilization. As a not limiting example, a prompt created during prompt creation could be “room 123 is too hot, what could potentially be the problem?” The natural language portion of the question could be created by a query (e.g., input query 706). Additionally included in the prompt could be graph data (e.g., building graph 702, graph digest 704), which could include, but is not limited to nodes, edges, and relationships that include data, instruments, equipment, relationships, and/or any other data contained by the graph. In some embodiments, prompt creation 712 only pulls relevant nodes and/or edges, creating a fine-tuned graph, lessening the burden of the prompt size. In some embodiments, the prompt could include examples and reasoning (e.g., relevant examples and reasoning 708), which could include data relevant to the prompt. For example, an example and reasoning could include data describing when and why a different room in a same or different building was too hot, and how it may have been fixed. In some embodiments, prompt creation 712 includes input from a summary (e.g., summary of fetched data points) within the orchestrator. For example, a summary of data pulled from a previous cycle of the orchestrator can be input into prompt creation 712.

System 700 is shown to include or be coupled with one or more models 714. The one or more processors described herein may execute the model 714. The model 714 can include one or more neural networks, including neural networks configured as generative models. For example, the model 714 can predict or generate new data (e.g., artificial data, synthetic data, etc.). The model 714 can generate any of a variety of modalities of data, such as queries (e.g., graph query 718), text, speech, audio, images, and/or video data. For example, the model 714 can generate queries to traverse given portions of the plurality of portions to retrieve corresponding information from the given portions. For example, model 714 can generate a query (e.g., graph query 718) by collecting pairs of natural language indicators and create corresponding queries. Once trained, the model 714 can generate queries from natural language inputs. The neural network can include a plurality of nodes, which may be arranged in layers for providing outputs of one or more nodes of one layer as inputs to one or more nodes of another layer. The neural network can include one or more input layers, one or more hidden layers, and one or more output layers. Each node can include or be associated with parameters such as weights, biases, and/or thresholds, representing how the node can perform computations to process inputs to generate outputs. The parameters of the nodes can be configured by various learning or training operations, such as unsupervised learning, weakly supervised learning, semi-supervised learning, or supervised learning.

The model 714 can include, for example and without limitation, one or more language models, LLMs, attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof. In some embodiments, the model 714 can include at least one GPT model. The GPT model can receive an input sequence, and can parse the input sequence to determine a sequence of tokens (e.g., words or other semantic units of the input sequence, such as by using Byte Pair Encoding tokenization).

The model 714 can include or be coupled with a vocabulary of tokens, which can be represented as a one-hot encoding vector, where each token of the vocabulary has a corresponding index in the encoding vector; as such, the model 714 can convert the input sequence into a modified input sequence, such as by applying an embedding matrix to the token tokens of the input sequence (e.g., using a neural network embedding function), and/or applying positional encoding (e.g., sin-cosine positional encoding) to the tokens of the input sequence. The model 714 can process the modified input sequence to determine a next token in the sequence (e.g., to append to the end of the sequence), such as by determining probability scores indicating the likelihood of one or more candidate tokens being the next token, and selecting the next token according to the probability scores (e.g., selecting the candidate token having the highest probability scores as the next token). For example, the model 714 can apply various attention and/or transformer based operations or networks to the modified input sequence to identify relationships between tokens for detecting the next token to form the output sequence.

In some embodiments, the model 714 can include at least one diffusion model, which can be used to generate image and/or video data. For example, the diffusional model can include a denoising neural network and/or a denoising diffusion probabilistic model neural network. The denoising neural network can be configured by applying noise to one or more training data elements (e.g., images, video frames) to generate noised data, providing the noised data as input to a candidate denoising neural network, causing the candidate denoising neural network to modify the noised data according to a denoising schedule, evaluating a convergence condition based on comparing the modified noised data with the training data instances, and modifying the candidate denoising neural network according to the convergence condition (e.g., modifying weights and/or biases of one or more layers of the neural network). In some implementations, the model 714 includes a plurality of generative models, such as GPT and diffusion models, that can be trained separately or jointly to facilitate generating multi-modal outputs, such as technical documents (e.g., service guides) that include both text and image/video information.

In some implementations, the model 714 can be configured using various unsupervised and/or supervised training operations. The model 714 can be configured using training data from various domain-agnostic and/or domain-specific data sources, including but not limited to various forms of text, speech, audio, image, and/or video data, or various combinations thereof. The training data can include a plurality of training data elements (e.g., training data instances). Each training data element can be arranged in structured or unstructured formats; for example, the training data element can include an example output mapped to an example input, such as a query representing a service request or one or more portions of a service request, and a response representing data provided responsive to the query. The training data can include data that is not separated into input and output subsets (e.g., for configuring the first model 714 to perform clustering, classification, or other unsupervised ML operations). The training data can include human-labeled information (e.g., input query 706, relevant examples and reasoning 708, etc.), including but not limited to feedback regarding outputs of the model 714. This can allow the system 700 to generate more natural language or human-like outputs. In some embodiments, the model can be trained to understand a context of the one or more graphs (e.g., building graphs). For example, the model 714 can be configured and/or trained to generate queries to traverse given portions of the plurality of portions to retrieve corresponding information from the given portions.

In some implementations, the training data includes data relating to building management systems. For example, the training data can include examples of digital twin data structures, databases (e.g., database 155), data lakes, data repositories, documentation records, graphs, graph digests (e.g., graph digest 704), queries (e.g., input query 706), user queries, relevant example and reasoning, summaries, HVAC-R data, such as operating manuals, technical data sheets, configuration settings, operating setpoints, diagnostic guides, troubleshooting guides, user reports, technician reports. In some implementations, the training data used to configure the model 714 includes at least some publicly accessible data, such as data retrievable via the Internet. In some implementations, the model 714 can be trained on selections of a graph digest. For example, the graph digest can include one or more relationship clusters within the one or more building graphs. The relationship clusters can include extractions of a plurality of portions of the one or more building graphs. The model 714 can be trained using one or more relationship clusters of a graph digest. The model 714 can generate a graph query (e.g., graph query 718) used to traverse given portions of the plurality of portions to retrieve corresponding information of the given portions. For example, the model 714 can be trained on one or more relationship clusters to allow the model 714 to digest the graph context without having to process the entirety of the graph.

System 700 can be shown to include a user-response 716. In some embodiments, user-response 716 allows for a user to interact to results provided orchestrator 750. In some embodiments, the user-response 716 can be sent to a device (e.g., user device, client device, etc.). In some embodiments, the user-response 716 can be generated by orchestrator 750 as a response to input query 706. For example, the user-response 716 can include an output generated by the orchestrator 750 as a result of the graph query 718 traversing a plurality of portions of the graph to retrieve corresponding information. In some embodiments, the user-response 716 can be used to further train a model (e.g., model 714) or stored as a stored query in a database (e.g., query structures 504 used in self-improvement framework 500). In some embodiments, a user can accept, reject, give feedback, or clarify the response. In some embodiments, the user-response 716 can include information relating a first building and/or systems within to a second building and/or systems within. For example, the user-response 716 can include a natural language explanation for a query (e.g., input query 706) related to building structure and connection between various entities. In some embodiments, the user-response 716 is generated as an electronic message.

System 700 can include a graph query 718. In some embodiments, the query is output provided by the model 714. For example, the graph query 718 can be generated by any of the methods used by the model 714. In some embodiments, the graph query 718 can be a SparQL Query. In some embodiments, the graph query 718 can be a Py-SparQL query. SparQL and Py-SparQL are RDF query languages known in the art to retrieve and manipulate data stored in RDF format. In some embodiments, graph query 718 can enable the system 700 to query information from databases (e.g., graph server 720). For example, the graph query 718 can contain collected pairs of natural language questions and corresponding queries. In some embodiments, graph query 718 can be used to traverse given portions responsive to one or more input queries 706.

System 700 can be shown to include a graph server 720. According to some embodiments, the graph server 720 can be run and/or loaded by any engine. For example, the graph server 720 can be run and/or loaded on a background engine. Additionally, the graph server 720 can be ran on a cloud platform. According to some embodiments, the graph server 720 can contain a loaded graph (e.g., loaded ontology graph) or a plurality of portions of a graph. For example, a graph server 720 can include a building graph (e.g., Brick graph, RDF graph, etc.) or clustered portions of a building graph. In some embodiments, the building graph can be a first building graph (e.g., building graph 702) created from a first building, or a second building graph created from a second building. The loaded graph on the graph server can be the same or different loaded graph used for prompt creation (e.g., building graph 702). The one or more processors discussed herein can execute the query on the data contained on the graph server 720. That is, the graph server 720 can output filtered data or information from the graph (e.g., filtered data 722).

System 700 can include filtered data 722. In some embodiments, filtered data 722 can include any type of data included in a query, prompt, held in a graph, or otherwise available in the systems discussed herein. For example, filtered data 722 can include a portion of a graph (e.g., graph server 720, building graph 702, graph digest 704). That is filtered data 722 could include graph items, graph structure, queries, natural language results, reasoning, etc. Filtered data 722 can be stored, moved, written, received, provided, transmitted, or otherwise used by any system or process described herein. Filtered data 722 can include a threshold, wherein the threshold can be related to a prompt. The thresholds can be based on information from various data sources. The thresholds can include, for example and without limitation, thresholds based on information such as equipment limitations, safety margins, physics, expert teaching, etc. For example, the filtered data 722 can include thresholds determined from various models, functions, or data structures (e.g., tables) representing physical properties and processes, such as physics of psychometrics, thermodynamics, and/or fluid dynamics information. Additionally, thresholds can be associated with the completion and/or prompt presented by prompt creation 712. For example, the systems described herein can use the prompts and model interaction with queries and server to identify real thresholds for ranges, setpoints, and/or start-up or operating sequences regarding items of equipment (and which can thus be validated by human experts (e.g., user-response 716)).

System 700 can include a summary 724. In some embodiments, summary 724 can include the filtered data 722 or a summary of filtered data 722. In some embodiments, summary 724 can be input for prompt creation and/or training data for a model. The summary 724 can be executed, stored, or otherwise used by any of the systems or system components described herein. In some embodiments, summary 724 can include valuable insights and a high-level overview of information contained within a graph (e.g., graph server 720). For example, a summary 724 can include, but is not limited to entity counts, relationships and connections, data trends, anomalies, outliers, spatial distribution, operational status.

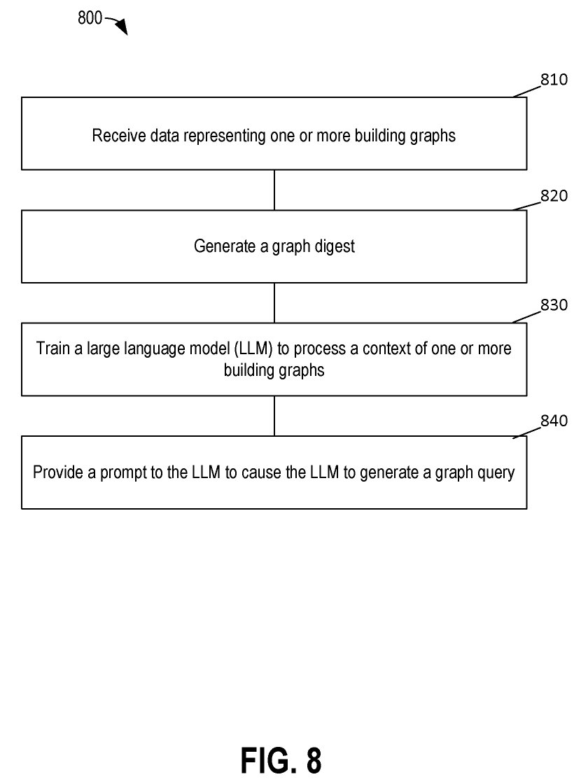

FIG. 8 is a flow diagram of a method 800 for generating a graph query for a building management system, according to some embodiments. In some embodiments, at least one of the various systems described herein may perform at least one step and/or operation of the method 800. For example, the graph management system 105 may perform at least one step of the method 800. While several steps and/or operations of the method 800 are described as being performed by a given system, device, and/or component, the method 800 and/or portions thereof may be performed by one or more systems, devices, and/or components.

At step 810, one or more processing circuits can receive data representing one or more building graphs. The one or more processing circuits can receive the data from one or more data sources. The one or more building graphs can include nodes that represent entities of a building and edges that represent relationships between the nodes. For example, the information retrieval system 700 can receive a building graph 702 that includes nodes representing entities such as HVAC equipment, rooms, floors, sensors, and/or controllers, among others. The edges of the building graph 702 can represent relationships between the nodes, such as location relationships, feed relationships, containment relationships, and/or control relationships, among others. In some implementations, the one or more processing circuits can receive the data from a database (e.g., the database 155) via a network (e.g., the network 170). In some implementations, the one or more building graphs can conform to a schema, such as the Brick schema, that provides a standardized semantic description of one or more assets of a building.

At step 820, the one or more processing circuits can generate a graph digest using the data. The graph digest can include one or more relationship clusters within the one or more building graphs. The relationship clusters can include extractions of portions of the one or more building graphs. That is, the one or more processing circuits can traverse the one or more building graphs and extract groups of related nodes and edges into the relationship clusters. For example, the information retrieval system 700 can generate a graph digest 704 from the building graph 702. The graph digest 704 can include relationship clusters for HVAC systems, power systems, room connections, sensor networks, and/or any other building relationship group. In some implementations, generating the graph digest can include generating a subject digest section that lists subject-node classes with parent category assignments, a predicate digest section that lists relationships with allowed subject and object node classes, and/or an object digest section that includes examples of object-node types. In some implementations, the one or more processing circuits can generate an adjacency matrix based on simultaneous occurrence of subject types in nodes of the one or more building graphs. The one or more processing circuits can use the adjacency matrix to identify related node-type groups. The one or more processing circuits can generate grouped digest sections based on the related node-type groups. For example, the grouped digest sections can include a location group containing building, room, floor, and zone node class types, an equipment group containing AHU, chiller, VAV, and FCU node class types, and/or a point group containing sensor and command node class types, among others.

At step 830, the one or more processing circuits can train a large language model to process a context of the one or more building graphs. That is, the one or more processing circuits can train the large language model using one or more relationship clusters of the graph digest such that the trained large language model can generate graph queries to traverse given portions of the one or more building graphs to retrieve corresponding information from the given portions responsive to one or more queries. For example, the information retrieval system 700 can train the model 714 using relationship clusters regarding sensor networks, equipment hierarchies, and/or spatial layouts within a building. Training the model 714 on relationship clusters can provide the model 714 with context for generating queries for traversing a graph without needing to ingest the entire graph. In some implementations, training the large language model can include constraining the large language model to generate graph queries rather than generating direct factual responses to user queries. That is, the one or more processing circuits can use the large language model as an internal tool for query generation, and the one or more processing circuits can execute the generated graph queries against the one or more building graphs to retrieve the corresponding information.

At step 840, the one or more processing circuits can provide a prompt to the large language model to cause the large language model to generate a graph query. In some implementations, the one or more processing circuits can receive a query relating to the building and generate, using the trained large language model, a response to the query by prompting the trained large language model to generate one or more graph queries into the one or more building graphs using the context obtained by training the large language model using the graph digest. For example, the one or more processing circuits can receive an input query 706 from a user for a first set of information associated with one or more aspects of a building. The information retrieval system 700 can generate a prompt based on one or more aspects of the input query 706 and one or more aspects of the graph digest 704. The information retrieval system 700 can provide the prompt as one or more inputs to the model 714 to cause the model 714 to generate a graph query 718 for the building graph 702. For example, the information retrieval system 700 can receive a natural language input query 706 from a user asking what rooms power unit A provides power to. The information retrieval system 700 can generate a prompt directing the model 714 to generate a graph query 718 to traverse the building graph 702 for information and relationships corresponding to power unit A.

In some implementations, prior to generating the prompt at step 840, the one or more processing circuits can identify reasoning of one or more stored input queries or one or more clusters of stored input queries based on a context of the input query 706. The reasoning can include one or more related queries, answers, and/or reasoning of the one or more stored input queries or the one or more clusters of stored input queries. The one or more processing circuits can generate the prompt based on the one or more aspects of the input query 706, the one or more aspects of the graph digest 704, and one or more aspects of the reasoning. For example, the self improvement framework 710 can retrieve relevant examples and reasoning 708 from the vector database 502 that correspond to prior queries about equipment-to-room relationships. The information retrieval system 700 can include the relevant examples and reasoning 708 in the prompt to provide context to the model 714 for generating the graph query 718.

In some implementations, the one or more processing circuits can traverse a given portion of the building graph based on the graph query 718 and retrieve corresponding information from the given portions. The graph query 718 can be executed on the graph server 720 to retrieve filtered data 722 (e.g., info from graph). The one or more processing circuits can generate a summary 724 of fetched data points based on the filtered data 722 (e.g., info from graph). For example, the information retrieval system 700 can execute the graph query 718 on the graph server 720 to retrieve a sub-graph of the building graph 702 containing nodes and edges associated with power unit A and connected rooms. The information retrieval system 700 can generate a summary 724 (e.g., of fetched data points) from the filtered data 722. In some implementations, the one or more processing circuits can determine an additional prompt based on one or more aspects of the input query 706, one or more aspects of the graph digest 704, and one or more aspects of the summary 724 of fetched data points. The one or more processing circuits can provide the additional prompt to the large language model to cause the large language model to generate a new graph query for the building graph to traverse given portions to retrieve corresponding information from the given portions responsive to the new graph query. That is, the one or more processing circuits can iterate through prompt generation, query execution, and summary generation until the corresponding information satisfies the input query 706 for the first set of information.

In some implementations, the one or more processing circuits can determine that the corresponding information satisfies the input query 706 for the first set of information. The one or more processing circuits can transmit, responsive to execution of the graph query 718, an electronic message to a computing device to provide the first set of information. For example, the information retrieval system 700 can generate a user-response 716 containing a natural language response that identifies the rooms to which power unit A provides power, and transmit the user-response 716 to a user device.

In some implementations, the one or more processing circuits can retrieve stored input queries from the vector database 502. The stored input queries can include data corresponding to an encapsulation of a natural language query and a corresponding natural language result. The one or more processing circuits can associate stored input queries into clusters based on similarity between the natural language query and the corresponding natural language result of the stored input queries. For example, the information retrieval system 700 can execute the clustering module 508 to group prior query structures 504 (e.g., result entries) into clusters. The one or more processing circuits can identify reasoning of one or more stored input queries or one or more clusters of stored input queries with a highest similarity to a context of the received input query 706. The reasoning can include information including one or more related queries, answers, and/or reasoning of the one or more stored input queries or the one or more clusters of stored input queries to the context of the received input query 706.

The one or more processing circuits can determine an additional prompt based on one or more aspects of the input query 706, one or more aspects of the graph digest 704, one or more aspects of the summary of fetched data points, and one or more aspects of the reasoning. The one or more processing circuits can provide the additional prompt to the large language model to cause the large language model to generate a new graph query for the building graph. In some implementations, the graph query 718 generated by the large language model can be a query that is executed on a cloud-based graph engine storing the building graph to retrieve a portion of the building graph without rendering the entire building graph.The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions, and arrangement of the exemplary embodiments without departing from the scope of the present disclosure.

The present disclosure contemplates methods, systems, and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps can differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

In various implementations, the steps and operations described herein can be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations can be performed by one or more local controllers or computing devices (e.g., edge devices), such as controllers dedicated to and/or located within a particular building or portion of a building. In some implementations, the operations can be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media (e.g., non-transitory computer-readable storage media) and/or one or more controllers, such computer-readable storage media and/or one or more controllers can be implemented as one or more central servers, one or more local controllers or computing devices (e.g., edge devices), any combination thereof, or any other combination of storage media and/or controllers regardless of the location of such devices.

What is claimed:

1. A system comprising one or more memory devices having instructions stored thereon, that, when executed by one or more processors, cause the one or more processors to:
receive data that represents a building graph, the building graph including (1) a plurality of nodes that represent entities of a building and (2) edges that represent relationships between the plurality of nodes;
generate, using the data, a graph digest comprising one or more relationship clusters within the building graph, the relationship clusters comprising extractions of a plurality of portions of the building graph; and
train, using one or more relationship clusters of the graph digest, a large language model (LLM) to process a context of the building graph such that the trained LLM is configured to generate graph queries to traverse given portions of the plurality of portions to retrieve corresponding information from the given portions responsive to one or more input queries.

2. The system of claim 1, wherein the instructions cause the one or more processors to:
receive an input query for a first set of information associated with one or more aspects of a building;
generate a prompt based on one or more aspects of the input query and one or more aspects of the graph digest;
provide, as one or more inputs, the prompt to the LLM to cause the LLM to generate a graph query for the building graph; and
traverse a given portion of the building graph based on the graph query and retrieve corresponding information from the given portions.

3. The system of claim 2, wherein the instructions cause the one or more processors to:
identify reasoning of one or more stored input queries or one or more clusters of stored input queries based on a context of the input query, wherein the reasoning includes one or more related queries, answers, or reasoning of the one or more stored input queries or the one or more clusters of stored input queries; and
generate the prompt based on the one or more aspects of the input query, the one or more aspects of the graph digest, and one or more aspects of the reasoning.

4. The system of claim 2, wherein the instructions cause the one or more processors to:
generate a summary of the given portion of the building graph based on the retrieved corresponding information;
determine an additional prompt based on one or more aspects of the input query, one or more aspects of the graph digest, and one or more aspects of the summary; and
provide the additional prompt to the LLM to cause the LLM to generate a new graph query for the building graph to traverse given portions of the plurality of portions to retrieve corresponding information from the given portions responsive to the new graph query.

5. The system of claim 2, wherein the instructions further cause the one or more processors to:
determine that the corresponding information satisfies the input query for the first set of information; and
transmit, responsive to execution of the graph query, an electronic message to provide the first set of information.

6. The system of claim 2, wherein the instructions cause the one or more processors to:
generate a summary of the given portion of the building graph based on the retrieved corresponding information;
retrieve stored input queries consisting of data corresponding to an encapsulation of a natural language query and a corresponding natural language result; and
associate stored input queries into clusters based on similarity between the natural language query and corresponding natural language result of the stored input queries.

7. The system of claim 2, wherein the instructions cause the one or more processors to:
identify reasoning of one or more stored input queries or one or more clusters of stored input queries with a highest similarity to a context of the received input query, wherein the reasoning includes information including one or more related queries, answers, and reasoning of one or more stored input queries or one or more clusters of stored input queries to the context of the received input query;
determine an additional prompt based on one or more aspects of the input query, one or more aspects of the graph digest, one or more aspects of a summary of the corresponding information, and one or more aspects of the reasoning; and
provide the additional prompt to the LLM to cause the LLM to generate a new graph query for the building graph.

8. The system of claim 7, wherein the instructions further cause the one or more processors to:
traverse a given portion of the building graph based on the graph query and retrieve corresponding information from the given portions;
determine the corresponding information satisfies the input query for the first set of information; and
transmit, responsive to execution of the graph query, an electronic message to a computing device to provide the first set of information.

9. The system of claim 2, wherein the graph query generated by the LLM comprises a query configured to be executed on a cloud-based graph engine storing the building graph to retrieve a portion of the building graph without a complete rendering of the building graph.

10. The system of claim 1, wherein the one or more relationship clusters of the graph digest comprise clusters of nodes and edges grouped according to node class hierarchies including a general node class, a parent node class, and one or more node class types corresponding to building or equipment parameters.

11. A method comprising:
receiving, by one or more processing circuits, data that represents a building graph, the building graph including (1) a plurality of nodes that represent entities of a building and (2) edges that represent relationships between the plurality of nodes;
generating, by the one or more processing circuits, using the data, a graph digest comprising one or more relationship clusters within the building graph, the relationship clusters comprising extractions of a plurality of portions of the building graph;
training, by the one or more processing circuits, using one or more relationship clusters of the graph digest, a large language model (LLM) to process a context of the building graph such that the trained LLM is configured to generate graph queries to traverse given portions of the plurality of portions to retrieve corresponding information from the given portions responsive to one or more queries;
receiving, by the one or more processing circuits, a query relating to the building; and
generating, by the one or more processing circuits using the trained LLM, a response to the query by prompting the trained LLM to generate one or more graph queries into the building graph using the context obtained by training the LLM using the graph digest.

12. The method of claim 11, further comprising:
receiving, by the one or more processing circuits, an input query for a first set of information associated with one or more aspects of a building;
generating, by the one or more processing circuits, a prompt based on one or more aspects of the input query and one or more aspects of the graph digest;
providing, by the one or more processing circuits, as one or more inputs, the prompt to the LLM to cause the LLM to generate a graph query for the building graph; and
traversing, by the one or more processing circuits a given portion of the building graph based on the graph query and retrieve corresponding information from the given portions.

13. The method of claim 12, further comprising:
identifying, by the one or more processing circuits, reasoning of one or more stored input queries or one or more clusters of stored input queries based on a context of the input query, wherein the reasoning includes one or more related queries, answers, or reasoning of the one or more stored input queries or the one or more clusters of stored input queries;
generating, by the one or more processing circuits, the prompt based on the one or more aspects of the input query, the one or more aspects of the graph digest, and one or more aspects of the reasoning.

14. The method of claim 12, further comprising:
generating, by the one or more processing circuits, a summary of the given portion of the building graph based on the retrieved corresponding information;
determining, by the one or more processing circuits, an additional prompt based on one or more aspects of the input query, one or more aspects of the graph digest, and one or more aspects of the summary; and
providing, by the one or more processing circuits, the additional prompt to the LLM to cause the LLM to generate a new graph query for the building graph to traverse given portions of the plurality of portions to retrieve corresponding information from the given portions responsive to the new graph query.

15. The method of claim 12, further comprising:
determining, by the one or more processing circuits, that the corresponding information satisfies the input query for the first set of information; and
transmitting, by the one or more processing circuits, responsive to execution of the graph query, an electronic message to a computing device to provide the first set of information.

16. The method of claim 12, further comprising:
generating, by the one or more processing circuits, a summary of the given portion of the building graph based on the retrieved corresponding information;
retrieving, by the one or more processing circuits, stored input queries consisting of data corresponding to an encapsulation of a natural language query and a corresponding natural language result; and
associating, by the one or more processing circuits, stored input queries into clusters based on similarity between the natural language query and corresponding natural language result of the stored input queries.

17. The method of claim 12, further comprising:
identifying, by the one or more processing circuits, reasoning of one or more stored input queries or one or more clusters of stored input queries with a highest similarity to a context of the received input query, wherein the reasoning includes information including one or more related queries, answers, and reasoning of one or more stored input queries or one or more clusters of stored input queries to the context of the received input query;
determining, by the one or more processing circuits, an additional prompt based on one or more aspects of the input query, one or more aspects of the graph digest, one or more aspects of a summary of the corresponding information, and one or more aspects of the reasoning; and
providing, by the one or more processing circuits, the additional prompt to the LLM to cause the LLM to generate a new graph query for the building graph.

18. The method of claim 17, further comprising:
traversing, by the one or more processing circuits, a given portion of the building graph based on the graph query and retrieve corresponding information from the given portions;
determining, by the one or more processing circuits, the corresponding information satisfies the input query for the first set of information; and
transmitting, by the one or more processing circuits, responsive to execution of the graph query, an electronic message to a computing device to provide the first set of information.

19. One or more non-transitory storage media storing instructions thereon that, when executed by one or more processors, cause the one or more processors to:
receive, from one or more data sources, data that represents a building graph, the building graph including (1) a plurality of nodes that represent entities of a building and (2) edges that represent relationships between the plurality of nodes;
generate, using the data, a graph digest comprising one or more relationship clusters within the building graph, the relationship clusters comprising extractions of a plurality of portions of the building graph; and
train, using one or more relationship clusters of the graph digest, a large language model (LLM) to process a context of the building graph such that the trained LLM is configured to generate graph queries to traverse given portions of the plurality of portions to retrieve corresponding information from the given portions responsive to one or more input queries.

20. The one or more non-transitory storage media of claim 19, wherein the instructions cause the one or more processors to:
receive an input query for a first set of information associated with one or more aspects of a building;
generate a prompt based on one or more aspects of the input query and one or more aspects of the graph digest;
provide, as one or more inputs, the prompt to the LLM to cause the LLM to generate a graph query for the building graph; and
traverse a given portion of the building graph based on the graph query and retrieve corresponding information from the given portions.
